(19) United States
(12) Patent Application Publication
(10) Pub. No.: US 2017/0226439 A1
(43) Pub. Date: Aug. 10, 2017

(54) SYSTEMS AND METHODS FOR FORMING CELLULOSIC BIOWASTE FROM MIXED SOLID WASTE

(71) Applicant: Abengoa Bioenergia Nuevas Tecnologias, S.A., Sevilla (ES)

(72) Inventors: Quang A. Nguyen, Chesterfield, MO (US); Ignacio Carvajo Lucena, Sevilla (ES); Vanesa Ramos Garces, Sevilla (ES); Pablo Cabeza Perez, Sevilla (ES); Ana Isabel Vicente Garcia, Sevilla (ES); Cristina Montejo Mendez, Sevilla (ES)

(21) Appl. No.: 15/515,421

(22) PCT Filed: Sep. 29, 2015
(86) PCT No.: PCT/US2015/052996

§ 371 Date: Mar. 29, 2017

(30) Foreign Application Priority Data
Sep. 30, 2014 (ES) P201431441

(51) Int. Cl. C10L 5/44; B03B 9/06; B07B 15/00

(52) U.S. Cl. CPC C10L 5/44; B07B 15/00; B03B 9/06

(57) ABSTRACT

The present disclosure generally relates to systems and methods for fractionating and sorting mixed solid waste comprising cellulosic biowaste (e.g., food and yard waste), inorganics, mixed plastics (e.g., HDPE and PET), metals, fiber (e.g., paper and cardboard), glass and wood to form various product streams including a purified cellulosic stream, an HDPE stream and a PET stream, and a waste stream enriched in inorganic compounds.

### CROSS-REFERENCE TO RELATED APPLICATION

This application claims priority to Spanish Patent Application No. P201431441, filed on 30 Sep. 2014, the entire disclosure of which is hereby incorporated by reference in its entirety.

### BACKGROUND

The field of the disclosure relates generally to methods for solid waste fractionation and for the production of useful products and recovery of recyclable matter from the various fractions. More particularly, the methods of the present disclosure relate to fractionation of municipal solid waste to provide a cleaned biowaste stream suitable for conversion to monosaccharides and to provide recyclable streams including high density polyethylene plastic and polyethylene terephthalate plastic.

Commercial, industrial, and residential consumers generate large quantities of solid waste (e.g., municipal solid waste (“MSW”)) that must be handled and disposed of in an environmentally responsible manner. Traditionally, MSW has been disposed of by landfilling or incineration. However, these methods of waste product disposal contaminate the soil, water and air and require use of land that could otherwise be used for other purposes.

MSW typically comprises significant quantities of recyclable material including components such as organic cellulosic biowaste (such as food waste, yard waste, wood, paper and cardboard), plastic, glass, ferrous metals, and non-ferrous metals (such as aluminum). MSW sorting operations for recovery of the various components are known in the art, but such known methods are typically inefficient. Prior art biowaste fractions are typically impure and are contaminated with various components, such as enzymatic hydrolysis and fermentation inhibitors, that render such cellulosic biowaste fractions generally unsuitable to conversion to monosaccharides and optional fermentation products at commercially acceptable rate and yield. For that reason, prior art MSW fractionation methods generally recover value form the organic biowaste by incineration (energy recovery), gasification (via pyrolysis), or composting.

A need therefore exists for systems and methods for forming cellulosic biowaste from mixed solid waste, such cellulosic biowaste of sufficient purity to allow for commercially acceptable rates of conversion to monosaccharides by enzymatic hydrolysis.

### BRIEF DESCRIPTION

In one aspect of the disclosure, a method for preparing a cleaned biowaste stream from mixed solid waste is provided, wherein the mixed solid waste comprises biowaste, inorganic compounds, mixed plastics, rolling stock, flat stock, bagged waste, and ferrous metals. The method comprises: (a) classifying mixed solid waste in a first classifying step to form a first undersize stream and a first oversize stream wherein (1) the first undersize stream has an average particle size of less than from about 60 mm to about 100 mm and is enriched in biowaste as compared to the first oversize stream and (2) the first oversize stream is enriched in rolling stock and flat stock as compared to the first undersize stream; (b) classifying the first oversize stream in a second classifying step to form a second undersize stream and a second oversize stream wherein (1) the second undersize stream has an average particle size of less than from about 170 mm to about 230 mm and is enriched in rolling stock as compared to the first oversize stream and (2) the second oversize stream is enriched in flat stock as compared to the second undersize stream; (c) classifying the second oversize stream by screening in a third classifying step to form a third undersize stream and a third oversize stream wherein (1) the third undersize stream has an average particle size of less than from about 320 mm to about 380 mm and is enriched in bagged waste as compared to the third oversize stream and (2) the third oversize stream is enriched in flat stock as compared to the second oversize stream; (d) classifying the second and third undersize streams in a fourth classifying step to form a fines stream, a rolling stock stream and a flat stock stream wherein (1) the fines stream is enriched in biowaste as compared to the rolling stock stream and the flat stock stream, (2) the rolling stock stream in enriched in plastic as compared to the fines stream and flat stock stream, and (3) the flat stock stream is enriched in paper and cardboard as compared to the fines stream and the rolling stock stream; (e) combining the first undersize stream and the fourth classifying step separation fines stream to form a combined biowaste stream and classifying the combined biowaste stream in a fifth classifying step to form a first reject stream and an oversize crude biowaste stream wherein (1) the first reject stream has an average particle size of less than from about 5 mm to about 15 mm and is enriched in inorganic compounds as compared to the crude biowaste stream and (2) the oversize crude biowaste stream is enriched in cellulose as compared to the first reject stream; (f) classifying the oversize crude biowaste stream in a sixth classifying step to form a second reject stream and an intermediate biowaste stream wherein the second reject stream has a greater density in grams per cm³ as compared to the intermediate biowaste stream and the second reject stream is enriched in inorganic compounds as compared to the intermediate biowaste stream; (g) classifying the intermediate biowaste stream in a seventh classifying step to form a cleaned biowaste undersize stream and a fourth oversize stream wherein (1) the cleaned biowaste stream has an average particle size of less than from about 20 mm to about 30 mm and is enriched in biowaste as compared to the fourth oversize stream and (2) the fourth oversize stream is enriched in paper and plastic as compared to the cleaned biowaste stream; and (h) classifying the fourth classifying step rolling stock stream in an eighth classifying step to form a rolling stock recovered plastics streams comprising an HDPE plastic stream, a PET plastic stream, and mixed plastic stream.

In another aspect of the disclosure, a method for preparing a cleaned biowaste stream from mixed solid waste is provided, wherein the mixed solid waste comprises biowaste, inorganic compounds, mixed plastics, rolling stock, flat stock, bagged waste and ferrous metals. The method comprises: (a) classifying mixed solid waste in a first classifying step to form a first undersize stream and a first oversize stream wherein (1) the first undersize stream has an average particle size of less than from 60 mm to 100 mm and enriched in biowaste as compared to the first oversize stream and (2) the first oversize stream is enriched in rolling stock and flat stock as compared to the first undersize stream; (b) classifying the first oversize stream in a second classifying step to form a second undersize stream and a second oversize stream wherein (1) the second undersize stream has an average particle size of less than 170 mm to 380 mm and is enriched in rolling stock as compared to the first oversize stream and (2) the second oversize stream is enriched in flat stock as compared to the second undersize stream; (c) classifying the second undersize stream in a third classifying step to form a fines stream, a rolling stock stream and a flat stock stream wherein (1) the fines stream is enriched in biowaste as compared to the rolling stock stream, (2) the rolling stock stream in enriched in plastic as compared to the fines stream and flat stock stream, and (3) the flat stock stream is enriched in paper and cardboard as compared to the fines stream and the rolling stock stream; (d) classifying the ballistic separator rolling stock stream in a fourth classifying step to form ballistic separation rolling stock recovered plastics streams comprising an HDPE plastic stream, a PET plastic stream, and mixed plastic stream; and (e) combining the first undersize stream and the third classifying step fines stream to form a combined biowaste stream and classifying the combined biowaste stream in a fifth classifying step to form a first reject stream and a purified oversize stream comprising cleaned biowaste wherein (1) the first reject stream has an average particle size of less than 5 mm to 15 mm and is enriched in inorganic compounds as compared to the purified oversize stream and (2) the purified oversize stream is enriched in cellulose as compared to the first reject stream.

In another aspect of the disclosure, an apparatus for classifying mixed solid waste comprising biowaste, inorganic compounds, mixed plastics, rolling stock, flat stock, bagged waste, ferrous metals, and residual derived fuel is provided. The apparatus comprises: (a) a first classifying screen having a mesh size of from about 60 mm to about 100 mm for receiving and classifying the mixed solid waste to form a first undersize stream and a first oversize stream wherein (1) the first undersize stream is enriched in biowaste as compared to the first oversize stream and (2) the first oversize stream is enriched in rolling stock and flat stock as compared to the first undersize stream; (b) a second classifying screen having a mesh size of from about 170 mm to about 230 mm for receiving and classifying the first oversize stream to form a second undersize stream and a second oversize stream wherein (1) the second undersize stream is enriched in rolling stock as compared to the first oversize stream and (2) the second oversize stream is enriched in flat stock as compared to the second undersize stream; (c) a third classifying screen having a mesh size of from about 320 mm to about 380 mm for receiving and classifying the second oversize stream to form a third undersize stream and a third oversize stream wherein (1) the third undersize stream is enriched in bagged waste as compared to the third oversize stream and (2) the third oversize stream is enriched in flat stock as compared to the second oversize stream; (d) a ballistic separator for receiving and classifying the second and third undersize streams to form a fines stream, a rolling stock stream and a flat stock stream wherein (1) the fines stream is enriched in biowaste as compared to the rolling stock stream and the flat stock stream, (2) the rolling stock stream in enriched in plastic as compared to the fines stream and flat stock stream, and (3) the flat stock stream is enriched in paper and cardboard as compared to the fines stream and the rolling stock stream; (e) a fourth classifying screen having a mesh size of from about 5 mm to about 15 mm for receiving and classifying the first undersize stream and the ballistic separation fines stream to form a combined biowaste stream to form a first reject stream and an oversize crude biowaste oversize stream wherein (1) the first reject stream is enriched in inorganic compounds as compared to the crude biowaste stream and (2) the oversize crude biowaste stream is enriched in cellulose as compared to the first reject stream; (f) a density separator for receiving and classifying the oversize crude biowaste stream to form a second reject stream and an intermediate biowaste stream wherein (1) the second reject stream has a greater density in grams per cm³ as compared to the intermediate biowaste stream and (2) the second reject stream is enriched in inorganic compounds as compared to the intermediate biowaste stream; (g) a fifth classifying screen having a mesh size of about 20 mm to about 30 mm to classify the intermediate biowaste stream and form a cleaned biowaste undersize stream and a fourth oversize stream wherein (1) the cleaned biowaste stream is enriched in biowaste as compared to the fourth oversize stream and (2) the fourth oversize stream is enriched in paper and plastic as compared to the cleaned biowaste stream; and (h) an optical sorter for classifying the ballistic separator rolling stock stream to form ballistic separation rolling stock recovered plastics streams comprising an HDPE plastic stream, a PET plastic stream, and mixed plastic stream.

In another aspect of the disclosure, an apparatus for classifying mixed solid waste comprising biowaste, inorganic compounds, mixed plastics, rolling stock, flat stock, bagged waste, ferrous metals, and residual derived fuel is provided. The apparatus comprises: (a) a first classifying screen having a mesh size of from about 60 mm to about 100 mm for receiving and classifying mixed solid waste to form a first undersize stream and a first oversize stream wherein (1) the first undersize stream is enriched in biowaste as compared to the first oversize stream and (2) the first oversize stream is enriched in rolling stock and flat stock as compared to the first undersize stream; (b) a second classifying screen having a mesh size of from about 170 mm to about 380 mm for receiving and classifying the first oversize stream to form a second undersize stream and a second oversize stream wherein (1) the second undersize stream is enriched in rolling stock as compared to the first oversize stream and (2) the second oversize stream is enriched in flat stock as compared to the second undersize stream; (c) a ballistic separator for receiving and classifying the second undersize stream to form a fines stream, a rolling stock stream and a flat stock stream wherein (1) the fines stream is enriched in biowaste as compared to the rolling stock stream, (2) the rolling stock stream in enriched in plastic as compared to the fines stream and flat stock stream, and (3) the flat stock stream is enriched in paper and cardboard as compared to the fines stream and the rolling stock stream; (d) an optical sorter for receiving and classifying the ballistic separator rolling stock stream to form ballistic separation rolling stock recovered plastics streams comprising an HDPE plastic stream, a PET plastic stream, and mixed plastic stream; and (e) a purification classifying screen having a mesh size of from about 5 mm to about 15 mm for receiving and classifying the first undersize stream and the ballistic separation fines stream to form a first reject undersize stream and a purification oversize stream comprising cleaned biowaste wherein (1) the first reject stream is enriched in inorganic compounds as compared to the purification oversize stream and (2) the purification oversize stream is enriched in cellulose as compared to the first reject stream.

### BRIEF DESCRIPTION OF THE DRAWINGS

FIG. 1 is a process flow diagram of a first aspect of the present disclosure.

FIG. 2 is a process flow diagram of a second aspect of the present disclosure.

FIG. 3 is a process flow diagram of a third aspect of the present disclosure.

FIG. 4 is a process flow diagram of a fourth aspect of the present disclosure.

FIG. 5 is a process flow diagram of a fifth aspect of the present disclosure.

FIG. 6 is a process flow diagram of a sixth aspect of the present disclosure.

FIG. 7 is a process flow diagram of a seventh aspect of the present disclosure.

### DETAILED DESCRIPTION

In the present disclosure, an integrated process for sorting solid waste comprising combinations of fractionating techniques including, but not limited to, hand separation, separation based on material size, separation based on material density, separation based on material dimension, separation based on material optical characteristics, and separation based material X-ray absorption characteristics is provided. The process provides for the efficient generation of various recovered high value streams for recycle and conversion to higher value products including (1) cleaned biowaste that is suitable for the production of glucose, (2) recovered streams for recycle including sorted plastics, paper, cardboard, beverage cartons, glass and/or metals, (3) residual derived fuel, (4) optional preparation of fermentation products from glucose, and (5) optional preparation of syngas from one or more isolated organic-rich streams.

More particularly, the apparatuses, methods and processes of the present disclosure provide for efficient MSW classification to provide for high a purity cleaned biowaste stream comprising cellulose and low concentrations of enzymatic and fermentation inhibitors, such as clay and inorganic salts, that is suitable for conversion to monosaccharides and optional fermentation products at commercially acceptable rate and yield. The present disclosure further provides for recyclable plastics streams that are sorted by plastic type, such as polyethylene terephthalate (“PET”), high density polyethylene (“HDPE”) and polyvinyl chloride (“PVC”). The present disclosure yet further provides for solid residual fuel (“SRF”) having a caloric value of at least 17 mega joules per kilogram that is suitable for use as an energy source for steam generation boilers and cement kilns. The present disclosure still further provides for recovery of paper and cardboard suitable for sale as scrap. The present disclosure yet further provides for various organic enriched streams suitable for conversion to secondary products by gasification.

As used herein, mixed solid waste refers to a waste stream comprising biowaste (e.g., food waste and yard waste), inorganics (e.g., dirt, rocks and debris), mixed plastics (e.g., at least PET and HDPE), metals (e.g., iron, steel, aluminum, brass and/or copper), fiber (e.g., paper and cardboard (“P & C”)), glass, textiles, rubber and wood. An example of mixed solid waste is MSW.

As used herein, MSW refers to a mixed solid waste stream predominantly comprising mixed residential and commercial waste. Although the precise composition of MSW various with the source, and the concentrations and ranges disclosed in this paragraph are not construed as limiting, MSW typically comprises, without limitation, components detailed in Table A below (wet basis):

TABLE A

| Component | Range 1 | Range 2 | Range 3 |
|---|---|---|---|
| Organic Fraction | 30% to 80% | 35% to 75% | 40% to 70% |
| Food Waste | 5% to 55% | 10% to 50% | 15% to 45% |
| Yard Waste | 2% to 25% | 3% to 20% | 5% to 15% |
| Metals | 0.1% to 10% | 0.5% to 5% | 1% to 3% |
| Plastics | 3% to 30% | 5% to 25% | 10% to 20% |
| PET | 0.1% to 5% | 0.5% to 3% | 1% to 2% |
| HDPE | 0.1% to 5% | 0.3% to 3% | 0.5% to 1.5% |
| Glass | 1% to 10% | 2% to 8% | 3% to 6% |
| Rubber, leather, | 1% to 20% | 3% to 15% | 6% to 11% |
| textiles | | | |
| Inorganic Material | 0.1% to 20% | 0.5% to 15% | 1% to 12% |
| Combustible Material | 5% to 35% | 10% to 30% | 15% to 25% |
| (e.g., wood) | | | |

Mixed solid waste and MSW may be further characterized as a mixture of (i) two-dimensional components such as paper, cardboard, plastic film and at least a portion of the mixed metal component and (ii) three dimensional objects such as bottles, cans, beverage cartons, inorganic material, glass, at least a portion of the mixed metal component, and a predominant portion of the organic fraction.

As used herein, “biowaste” refers to a fractionated stream enriched in organic material suitable for conversion to monosaccharides such as, for instance, glucose and/or xylose. Organic material includes, but is not limited to, starch, cellulose, lignocellulose and hemicellulose. Biowaste is characterized as comprising at least 30 wt. %, at least 35 wt. %, at least 40 wt. %, at least 45 wt. %, at least 50 wt. %, at least 55 wt. %, at least 60 wt. %, at least 65 wt. %, at least 70 wt. %, at least 75 wt. %, at least 80 wt. % or at least 85 wt. % organic material (i.e., “organic content”), and ranges thereof, such as from about 50 to about 85 wt. %, or from about 60 to about 80 wt. % organic material.

As used herein, “predominant”, “predominantly comprising” and “substantial” are defined as at least 50%, at least 75%, at least 90%, at least 95% or at least 99% on a w/w %, w/v % or v/v % basis.

As used herein, “recyclable material” refers to mixed solid waste components having value and including, but not limited to, paper, cardboard, metals, glass, beverage cartons, plastic, and combinations thereof.

As used herein, “enriched” refers to a fractionated process stream or a fractionated constituent having a concentration of a referenced component that is greater than the concentration of that component (i) in the process stream or in a constituent from which the fractionated process stream or fractionated constituent was produced or (ii) in one or more co-fractionated streams or one or more co-fractionation constituents.

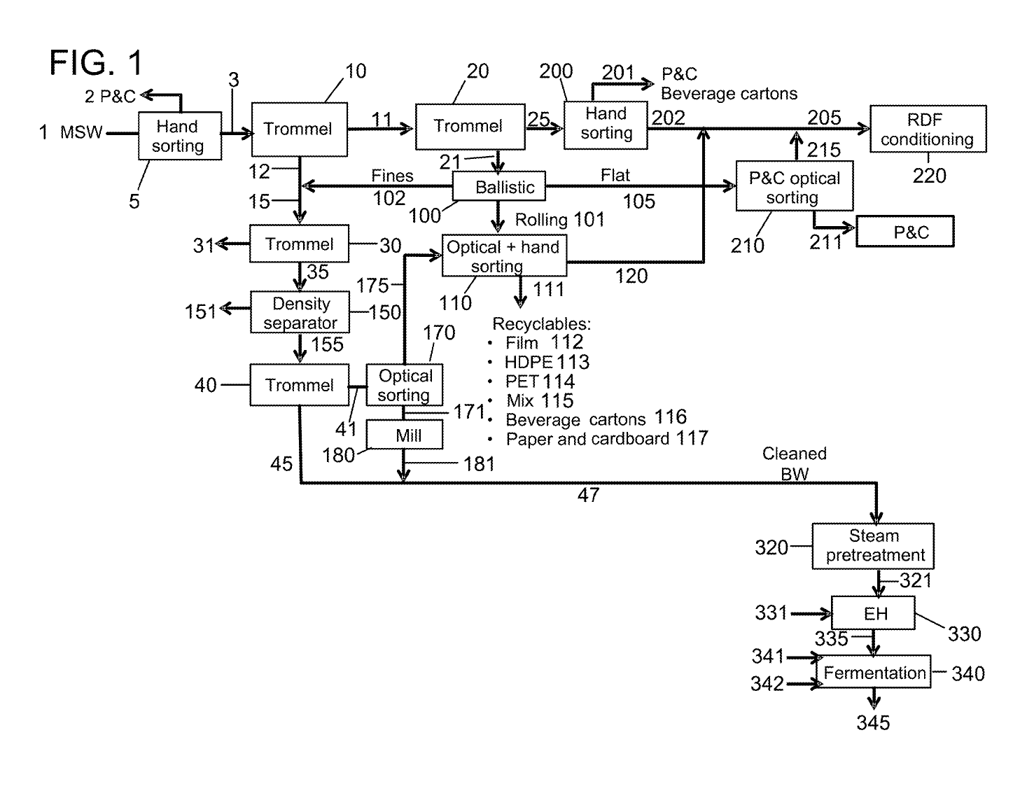

Various non-limiting aspects of the present disclosure are depicted in FIGS. 1 to 7.

FIG. 1 depicts one embodiment of the present disclosure wherein mixed solid waste 1 is optionally processed by a hand sorting step 5 to from a picked stream comprising one or more recyclable materials (e.g. paper and cardboard), combustible materials (e.g., wood), large or bulky waste and/or hazardous materials 2 and a raw feed stream 3. Raw feed stream 3 is fractionated in trommel 10 having a screen opening of from about 60 mm to about 100 mm (e.g., first classifying step) to form an undersize stream 12 enriched in fines as compared to raw feed stream 3 and an oversize stream 11 enriched in rolling stock and flat stock as compared to undersize stream 12. Undersize stream 12 is enriched in organic and inorganic material as compared to oversize stream 11. Oversize stream 11 is fractionated in a trommel 20 having openings of from about 170 mm to about 380 mm (e.g., second classifying step in some second aspects of the disclosure) to form an undersize stream 21 and an oversize stream 25. In some aspects of the present disclosure, trommel 20 comprises a two-stage screen with a first section having openings of from about 170 mm to about 230 mm (e.g., second classifying step in some first aspects of the disclosure) and a second stage having openings of from about 320 mm to about 380 mm (e.g., third classifying step in some first aspects of the disclosure). In some other aspects of the present disclosure, trommel 20 comprises two single-stage trommels in series with a first trommel having openings of from about 170 mm to about 230 mm and a second trommel having openings of from about 320 mm to about 380 mm. In such two-stage or serial single-stage trommel arrangements, second and third undersize streams (depicted collectively as 21) and second and third oversize streams (depicted collectively as 25) are generated wherein the second oversize stream is screened to form the third undersize stream and the thrid oversize stream is depicted as stream 25 in FIG. 1. Oversize stream 25 is optionally processed by a hand sorting step 200 to from a picked stream comprising recyclable material such as paper, cardboard, beverage cartons, glass and plastics 201 and a residual derived fuel (“RDF”) stream 202 enriched in combustible components. Undersize stream 21 is enriched in rolling stock as compared to oversize stream 25 and oversize stream 25 is enriched in flatstock as compared to undersize stream 21. When trommel 20 is a two-stage trommel or sequential single stage trommels, the undersize stream passing through the about 170 mm to about 230 mm openings is enriched in rolling stock (bottles) as compared to the undersize stream passing through the about 320 mm to about 380 mm openings, and the undersize stream passing through the about 320 mm to about 380 mm openings is enriched in bagged waste as compared to the undersize stream passing through the about 170 mm to about 230 mm openings. In optional aspects of the present disclosure (not depicted in FIG. 1), the 320-380 mm undersize stream may optionally be processed in a bag opener prior to further processing. Undersize or combined undersize streams 21 is/are fractionated by ballistic separation 100 (e.g., fourth classifying step in some first aspects of the disclosure and third classifying step in some second aspects of the disclosure) to form a rolling stock stream 101, a fines stream 102 and a flat stock stream 105. As compared to undersize stream 21, rolling stock stream 101 is enriched in bottles and cans, fines stream 102 is enriched in organic and inorganic compounds, and flat stock stream 105 is enriched in paper and cardboard. Fines stream 102 is combined with undersize stream 12 to form crude cellulosic biowaste stream 15.

In further reference to FIG. 1, crude cellulosic biowaste stream 15 is fractionated in a trommel 30 having openings of from about 5 mm to about 20 mm (e.g., fifth classifying step in some first aspects of the disclosure) to form an undersize stream 31 and an oversize stream 35. Undersize stream 31 predominantly comprises inorganic material and organic material where inorganic material is in excess. In some aspects of the present disclosure, undersize stream 31 is purged from the process as a reject stream. Oversize stream 35 is enriched in organic material such as cellulose, hemicellulose and starch, but further comprises some amount of inorganics and recyclable material comprising plastic. Oversize stream 35 is fractionated by density separation 150 (e.g., sixth classifying step in some first aspects of the disclosure) to form a stream of dense material 151 enriched in inorganic compounds as compared to oversize stream 35 and a stream of light materials 155 enriched in organic material as compared to oversize stream 35. The stream of light materials 155 (intermediate biowaste stream) is fractionated in a trommel 40 having openings of from about 20 mm to about 30 mm (e.g., seventh classifying step in some first aspects of the disclosure) to form cleaned biowaste stream 45 and oversize stream 41 (e.g., fourth oversize stream). Oversize stream 41 is fractionated by optical sorting 170 to recover an organic rich stream 171 and a recycle stream 175 that is enriched in recyclable material comprising plastic. The particle size of organic rich stream 171 is reduced in mill 180 to form biowaste stream 181 that is combined with cleaned biowaste stream 45 to form cleaned biowaste stream 47 for conversion to monosaccharides.

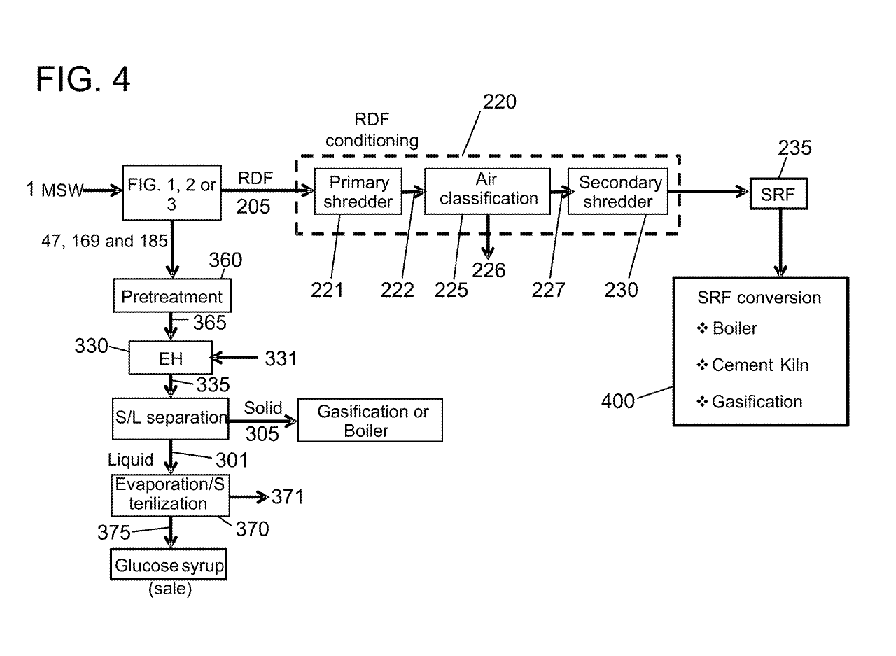

In further reference to FIG. 1, ballistic separation rolling stock stream 101 and recycle stream 175 are fractionated by optical sorting and hand sorting 110 (e.g., eighth classifying step in some first aspects of the disclosure and fourth classifying step in some second aspects of the disclosure) to form a series of recovered streams 111 including plastic film 112, HDPE plastic 113, PET plastic 114, mixed plastic 115, beverage cartons 116, paper/cardboard 117 and RDF stream 120. Ballistic separation flat stock stream 105 is optionally fractionated by optical sorting 210 to form RDF stream 215 and paper and cardboard stream 211. RDF streams 120, 202 and 215 are combined to form RDF stream 205 that is processed by RDF conditioning 220 described herein such as by, for instance, the process depicted in FIG. 4, to generate a combustible fuel source.

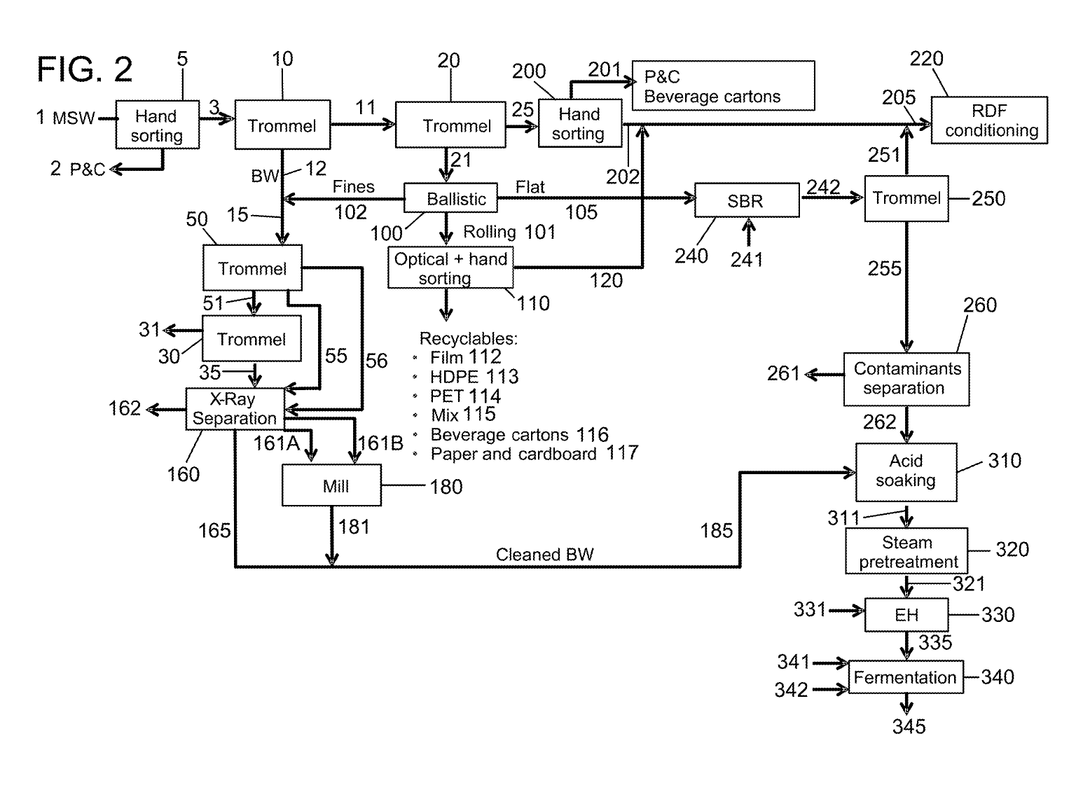

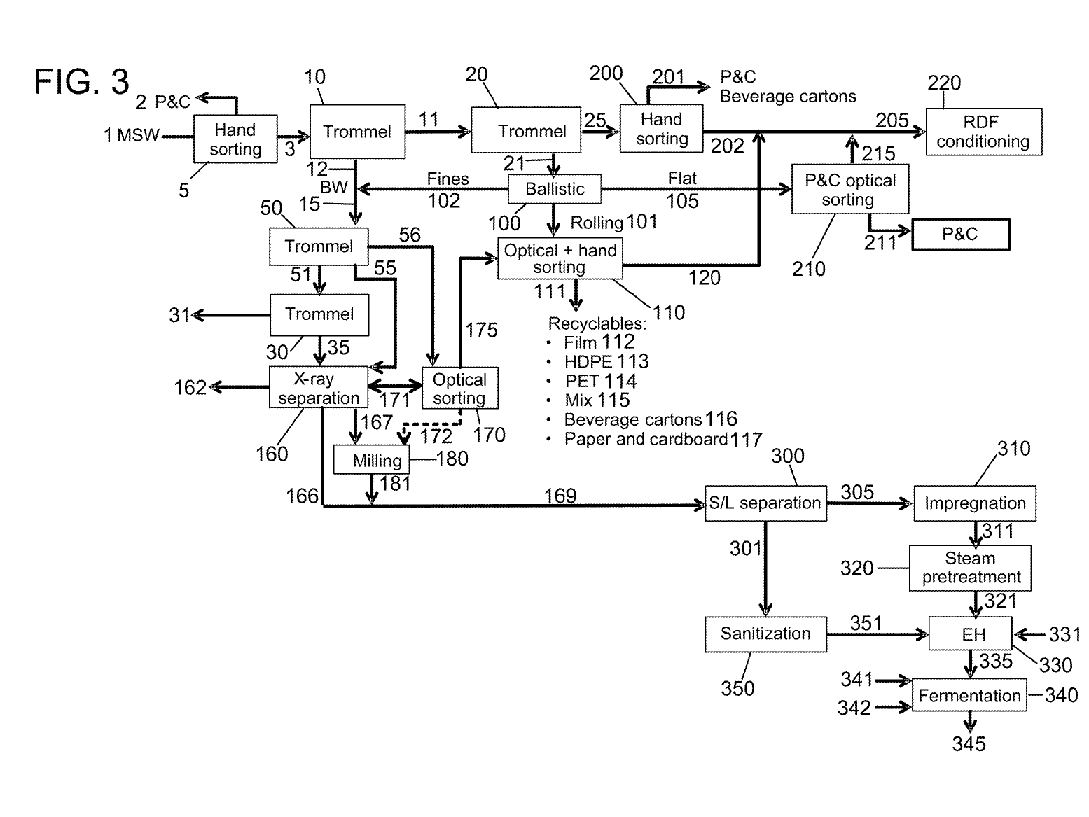

In any of the various aspects of the present disclosure, conversion of any of the various cleaned biowaste streams to monosaccharide sugars (such as glucose and xylose), and optional further conversion of monosaccharides to ethanol, may done according to a variety of methods. For instance, as depicted in FIG. 1, cleaned biowaste stream 47 may be processed by high temperature and pressure pretreatment, such as by direct contact with steam or by indirect heating 320 to form pretreated biowaste stream 321 wherein (1) lignocellulosic biomass contained therein is degraded to (i) at least partially free cellulose and hemicellulose from lignin thereby increasing the accessibility of cellulose and hemicellulose to enzymatic hydrolysis and (ii) generate xylose from hemicellulose degradation, (2) starch contained therein is gelatinized and (3) the stream is sterilized. In some aspects of the present disclosure (not depicted in FIG. 1), prior to steam pretreatment 320, the water content of the cleaned biowaste stream 47 is adjusted to from about 10 percent by weight (“wt. %”) to about 60 wt. % with an aqueous stream, an aqueous acid stream or an aqueous base stream. In enzymatic hydrolysis (“EH”) 330, pretreated biowaste stream 321 is cooled to less than about 60° C. and is contacted with an enzyme source 331 comprising cellulase and/or hemicellulase to form hydrolyzed biowaste stream 335 comprising unhydrolzyed cellulose, dextrin and the monosaccharide sugars glucose and xylose. As depicted in FIG. 1, hydrolyzed biowaste stream 335 is contacted with a source of at least one fermentation organism 341 in fermentation step 340 to convert glucose to a fermentation product 345 wherein the action of the enzyme source to generate fermentable monosaccharides. During fermentation step 340, additional monosaccharides are generated by enzymatic hydrolysis of cellulose resulting in simultaneous saccharification and fermentation (“SSF”). In some optional aspects, additional enzymes 342 may be added during fermentation. In some aspects of the present disclosure, the fermentation organism is yeast and the fermentation product is ethanol. Conversion of cleaned biowaste stream 47 to monosaccharides and fermentation products is not limited to the scheme depicted in FIG. 1. Cleaned biowaste stream 47 may instead be suitably converted to monosaccharides and fermentation products according to any method within the scope of the present disclosure, such as, for instance, the schemes depicted in any of FIG. 2 or 3.

FIG. 2 depicts a second embodiment of the present disclosure generally corresponding to FIG. 1 in connection with the hand sorting 5 (optional), trommel 10, trommel 20, ballistic separation 100 and hand sorting 200 fractionating steps and oversize stream 11, undersize stream 12, fines stream 102, crude cellulosic biowaste stream 15, undersize stream 21, oversize stream 25, rolling stock stream 101, flat stock stream 105, and RDF stream 202 enriched in combustible components. In further connection with FIG. 2, crude cellulosic biowaste stream 15 is fractionated in a trommel 50 that is a two stage trommel having a first section with openings of from about 20 mm to about 30 mm and a second section having openings of from about 40 mm to about 60 mm to form a first primary undersize stream 51 that passes through the 20 mm to 30 mm openings, a second primary undersize stream 55 that passes through the 40 mm to 60 mm openings and a primary oversize stream 56 wherein the first primary undersize stream 51 is enriched in inorganic compounds as compared to the second primary undersize stream 55. In some aspects trommel 50 may comprise two sequentially arranged single-screen trommels. In some optional aspects, trommel 50 is a single stage trommel having openings of from about 20 mm to about 30 mm and a single primary oversize stream 55/56 may be processed by X-ray separation 160. First primary undersize stream 51 is fractionated in trommel 30 having openings of from about 5 mm to about 15 mm (e.g., fifth classifying step in some second aspects of the disclosure) to form an undersize stream 31 (the first reject stream in some aspects of the disclosure) and an oversize stream 35 (purified stream in some aspects of the disclosure). Undersize stream 31 predominantly comprises inorganic material and organic material where inorganic material is in excess. In some aspects of the present disclosure, undersize stream 31 is purged from the process. In some aspects, oversize stream 35 (purified stream) is enriched in organic material such as cellulose, hemicellulose and starch. Oversize stream 35, undersize stream 55 and oversize stream 56 are fractionated by X-ray separation 160 to form biowaste stream 165 having an average particle size of less than about 25 mm and biowaste streams 161A and 161B, each having a particle size of greater than about 25 mm, and stream 162 that is enriched in inorganic material as compared to any of streams 161A, 161B and 165.

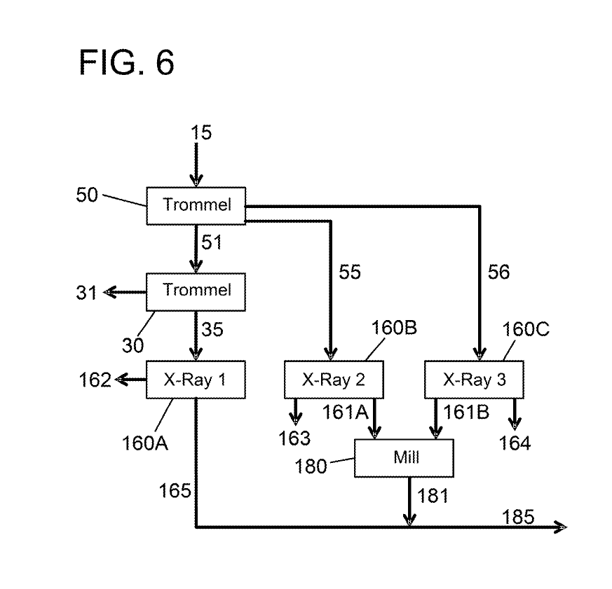

In one optional aspect depicted in FIG. 6, X-ray separation 160 may comprise 3 X-ray separation steps: 160A for processing stream 35 to form biowaste rich stream 165 and inorganic rich stream 162; 160B for processing stream 55 to form biowaste rich stream 161A and inorganic rich stream 163; and 160C for processing stream 56 to form biowaste rich stream 161B and inorganic rich stream 164. The particle size of biowaste streams 161A and 161B are reduced in mill 180 to form biowaste stream 181 that is combined with biowaste stream 165 to form cleaned biowaste stream 185 for conversion to monosaccharides. Any of streams 162, 163 or 164 may be optionally purged from the process or further fractionated such as by optical sorting step 110, by density separation (not depicted), by a dedicated optical sorting step (not depicted), or a combination thereof.

In further reference to FIG. 2, ballistic separation rolling stock stream 101 is fractionated by optical sorting and hand sorting 110 to form a series of recovered streams 111 including plastic film 112, HDPE plastic 113, PET plastic 114, mixed plastic 115, beverage cartons 116, paper/cardboard 117 and RDF stream 120. Ballistic separation flat stock stream 105 is processed in a sequential batch reactor (“SBR”) 240 by contact with steam 241 with homogenation to form stream 242 comprising a partial hydrolyzate of at least a portion of the organic matter contained therein. Stream 242 is fractionated in trommel 250 having openings of from about 5 mm to about 15 mm to form an undersize stream 255 enriched in cellulosic components and an oversize stream 251 enriched in combustible material. Undersize stream 255 is processed in a contaminant separation step 260 to remove inert components therefrom as stream 261 and form an oligosaccharide-rich stream 262 for combination with cleaned biowaste stream 185 for conversion to monosaccharides. Contaminants separation step 260 may be any unit operation suitable for separating and removing inert compounds, inorganic compounds, enzymatic hydrolysis inhibitors and/or fermentation inhibitors from organic material such as cellulose, hemicellulose, lignocellulose and starch. In some aspects of the present disclosure, separation step 260 suitably comprises forming an aqueous slurry of undersize stream 255, pulping the slurry, removing contaminants 261 as a sludge, and dewatering to remove additional contaminants with the liquid phase and form an oligosaccharide-rich stream 262. In some other aspects of the present disclosure, separation step 260 suitably comprises a dry separation step wherein undersize stream 255 is fractionated to remove a fine particulate fraction 261 enriched in inorganic components (ash) as compared to oligosaccharide-rich stream 262.

In further reference to FIG. 2, residual derived fuel streams 120, 202 and 251 are combined to form RDF stream 205 that may be processed by RDF conditioning described herein such as by, for instance, RDF conditioning 220 depicted in FIG. 4, to generate a combustible fuel source. Cleaned biowaste stream 185 and oligosaccharide-rich stream 262 may optionally be processed by impregnation 310 to form impregnated biowaste stream 311. In any of the various aspects of the present disclosure, cleaned biowaste stream 185 and oligosaccharide-rich stream 262 may be impregnated with water, aqueous acid (e.g., sulfuric acid) or aqueous base (e.g., ammonium hydroxide) to a water content of from about 10 wt. % to about 60 wt. %. Impregnated biowaste stream 311 is processed by high temperature and pressure steam pretreatment 320 to form pretreated biowaste stream 321 wherein (1) lignocellulosic biomass contained therein is degraded to (i) at least partially free cellulose and hemicellulose from lignin thereby increasing the accessibility of cellulose and hemicellulose to enzymatic hydrolysis and (ii) generate xylose from hemicellulose degradation, (2) starch contained therein is gelatinized and (3) the stream is sterilized. In some aspects of the present disclosure, (i) pretreated biowaste stream 321 is cooled to from about 70° C. to about 100° C. and (ii) the pH is adjusted, if necessary Enzymatic hydrolysis 330, of pretreated biowaste stream 321 by contact with an enzyme source 331 comprising cellulase and/or hemicellulase to form hydrolyzed biowaste stream 335, contact thereof with a source of at least one fermentation organism 341 in fermentation step 340, and optionally contacted with additional enzymes 342, to form a fermentation product 345 proceeds as described in connection with FIG. 1. Cleaned biowaste stream 185 and solid biowaste-rich component stream 262 may instead be suitably converted to monosaccharides and fermentation products according to any other method within the scope of the present disclosure, such as, for instance, the schemes depicted in any of FIGS. 1 (i.e., in the absence of impregnation), and 3.

FIG. 3 depicts a third embodiment of the present disclosure generally corresponding to FIG. 2 in connection with the hand sorting 5 (optional), trommel 10, trommel 20, trommel 50, trommel 30, ballistic separation 100, hand sorting 200 fractionating steps and oversize stream 11, undersize stream 12, fines stream 102, crude cellulosic biowaste stream 15, rolling stock stream 101, undersize stream 21, oversize stream 25, undersize stream 51, oversize stream 35, oversize stream 55, flat stock stream 105, undersize stream 31 and RDF stream 202. In further connection with FIG. 3, undersize stream 35 from trommel 30 is fractionated by X-ray separation 160 to form stream 166 wherein a plurality of the objects contained therein are characterized as having an average particle size in the largest dimension of less than about 25 mm and stream 162 that is enriched in inorganic material as compared to stream 166. Oversize stream 56 is fractionated in an optical sorting step 170 to form biowaste stream 171 and recycle stream 175 wherein biowaste stream 171 is enriched in organic compounds as compared to recycle stream 175 and recycle stream 175 is enriched in recyclable material comprising plastic as compared to biowaste stream 171. In FIG. 3, stream 172 is indicated by a dashed line and stream 171 is indicated as a bi-directional flow to indicate certain optional aspects as described elsewhere herein. Biowaste stream 171 and oversize stream 55 from trommel 50 are fractionated by X-ray separation 160 to form biowaste rich stream 167 wherein a plurality of the objects contained therein are characterized as having an average particle size in the largest dimension of from about 25 mm to about 80 mm and a portion of stream 162 that is enriched in inorganic material as compared to stream 167. The particle size of biowaste stream 167 is reduced in milling step 180 to form milled biowaste 181 that is combined with cleaned biowaste stream 166 to form biowaste stream 169 for conversion to monosaccharides and fermentation products.

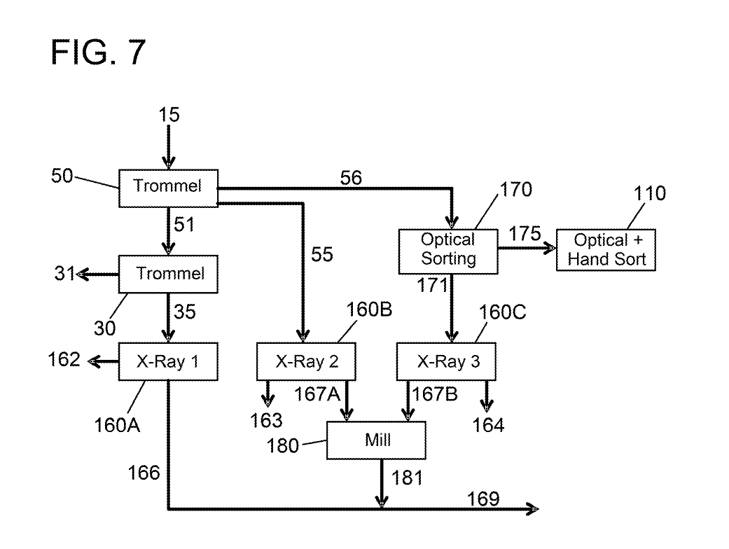

In one optional aspect depicted in more detail in FIG. 7, X-ray separation 160 may comprises 3 X-ray separation steps: 160A for processing stream 35 to form biowaste rich stream 166 and inorganic rich stream 162; 160B for processing stream 55 to form biowaste rich stream 167A and inorganic rich stream 163; and 160C for processing stream 171 from optical sorting to form biowaste rich stream 167B and inorganic rich stream 164. Streams 167A and 167B each have an average particle size in the largest dimension of greater than about 25 mm and comminuted in mill 180 to form biowaste stream 181 that is combined with biowaste stream 166 to form cleaned biowaste stream 169 for conversion to monosaccharides. Any of streams 162, 163 or 164 may be optionally purged from the process or further fractionated such as by optical sorting step 110, by density separation (not depicted), by a dedicated optical sorting step (not depicted), or a combination thereof.

In another optional aspect, in reference to FIG. 3, oversize streams 35, 55 and 56 may be classified in a series of X-ray separation steps 160, to form streams 162 (an inorganic rich stream), 166 (an organic rich stream having an average particle size of less than about 25 mm), 167 (an organic rich stream having an average particle size of from about 25 mm to about 50 mm), and 171 (a recycle stream enriched in plastic and further comprising organic material, and having an average particle size of from about 25 mm to about 80 mm). In such aspects, stream 56 is processed by X-ray separation 160 instead of by optical sorting 170. Stream 171 is processed by optical sorting 170 to generate recycle stream 175 enriched in plastics and stream 172 enriched in organic material as compared to stream 175. Organic rich streams 167 and 172 may be milled and combined with stream 166.

In further reference to FIG. 3, ballistic separation rolling stock stream 101 and recycle stream 175 are fractionated by a method generally corresponding to FIG. 1 in connection with the rolling stock optical sorting and hand sorting step 110 and ballistic flat stock stream 105 optional optical sorting step 210 to form recovered streams 111 including plastic film 112, HDPE plastic 113, PET plastic 114, mixed plastic 115, beverage cartons 116, paper/cardboard 117, RDF stream 120, RDF stream 215 and paper and cardboard stream 211. RDF streams 120, 202 and 215 are combined to RDF stream 205 that is processed by RDF conditioning 220 described herein such as by, for instance, the RDF conditioning 220 depicted in FIG. 4 to generate a combustible fuel source.

In further reference to FIG. 3, in some aspects of the present disclosure, biowaste stream 169 is combined with at least one aqueous stream to form a mixable slurry. Soluble biowaste components comprising monosaccharide sugars partition to the aqueous phase and the slurry is subjected to solid-liquid separation 300 to form liquid biowaste stream 301 comprising soluble monosaccharides and solid biomass stream 305 comprising insoluble biowaste components comprising cellulose, lignocellulose, hemicellulose and starch. Solid-liquid separation may suitably be filtration or centrifugation. In some other aspects of the present disclosure, biowaste stream 169 is retained on a filtration screen or centrifuge screen and an aqueous medium is passed through the biowaste stream 169 to extract soluble monosaccharides therefrom and form liquid biowaste stream 301 and solid biomass stream 305. In any such aspect, solid biomass stream 305 is hydrolyzed to form pretreated biowaste stream 321 by impregnation 310 to form impregnated solid biomass 311 followed by steam pretreatment 320 (optionally including contact with α-amylase) as generally described in connection with FIG. 2. Liquid biowaste stream 301 is sterilized in sanitization operation 350 by any suitable method such as high temperature and/or ultraviolent light and the sterilized liquid biowaste stream 351 is combined with pretreated biowaste stream 321. The combined streams are contacted with a source of enzyme comprising cellulase and/or hemicellulase 331 in an enzymatic hydrolysis operation 330 to form hydrolyzed biowaste stream 335 comprising dextrin and the monosaccharide sugars glucose and xylose as described herein in connection with FIGS. 1 and 2. Hydrolyzed biowaste stream 335 is combined with a source of at least one fermentation organism 341 in fermentation step 340, and optionally contacted with additional enzymes 342, to convert glucose to a fermentation product 345 as described herein in connection with FIGS. 1 and 2.

FIG. 4 depicts a fourth embodiment of the present disclosure for RDF 205 processing and processing of cleaned biowaste stream 47, biowaste stream 169 and cleaned biowaste stream 185 to glucose syrup. In the RDF conditioning 220, the particle size of RDF stream 205 is reduced in primary shredder 221 to form a shredded stream 222 that is fractionated by air classification 225 to form a heavies stream 226 enriched in non-combustible material as compared to light stream 227. The particle size of light stream 227, enriched in combustible material as compared to heavy stream 226, is reduced in secondary shredder 230 to form SRF 235. Optionally, not depicted in FIG. 4, SRF 235 may be dried to increase its heating value and to improve material handling characteristics. In SRF conversion 400, SRF is for use as a fuel source in incineration and co-incineration, such for boilers and cement kilns or can suitably be converted to hydrocarbons of varying length or mixed alcohols by gasification methods known in the art as described elsewhere herein.

As further depicted in FIG. 4, any of cleaned biowaste stream 47 (FIG. 1) biowaste stream 169 (FIG. 3) or cleaned biowaste stream 185 (FIG. 2), collectively termed cleaned biowaste streams, may be converted to glucose syrup. In a first step, the cleaned biowaste stream is subjected to pretreatment 360 to form pretreated biowaste 365. Pretreatment 360 generally encompasses high temperature and high pressure steam treatment of a biowaste material, and optionally further comprises impregnation with water, acid or base prior to steam pretreatment, as described elsewhere herein as described in connection with FIGS. 1 to 3. In some aspects of the present disclosure, pretreated biowaste 365 may be contacted with α-amylase after appropriate cooling and pH adjustment to form dextrin from gelatinized starch. Enzymatic hydrolysis 330 of pretreated biowaste 365 by contact with an enzyme source comprising cellulase 331 to form hydrolyzed biowaste stream 335 is as described elsewhere herein in connection with FIGS. 1 to 3. Hydrolyzed biowaste stream 335 is separated into liquid stream 301 comprising glucose and solid biomass stream 305 comprising insoluble biowaste components comprising cellulose, hemicellulose, lignocellulose, lignin and starch. Separation may suitably be done by filtration or centrifugation. Liquid stream 301 is sterilized and concentrated 370 to remove water 371 and form a glucose concentrate syrup 375. In some aspects of the present disclosure, sterilization and concentration may accomplished by distillation, such as vacuum distillation. In some other aspects of the present disclosure sterilization may be done by high temperature treatment or UV radiation, and concentration may accomplished by reverse osmosis or chromatography. In yet other aspects of the present disclosure, not depicted in FIG. 4, glucose may be separated from a mixture of other monosaccharides such as fructose, xylose, galactose and arabinose by chromatographic separation utilizing a suitable resin such as a strong cationic resin. Solid biomass stream may optionally be used as a fuel source in incineration and co-incineration, such for boilers and cement kilns or can suitably be converted to hydrocarbons of varying length or mixed alcohols by gasification methods known in the art as described elsewhere herein.

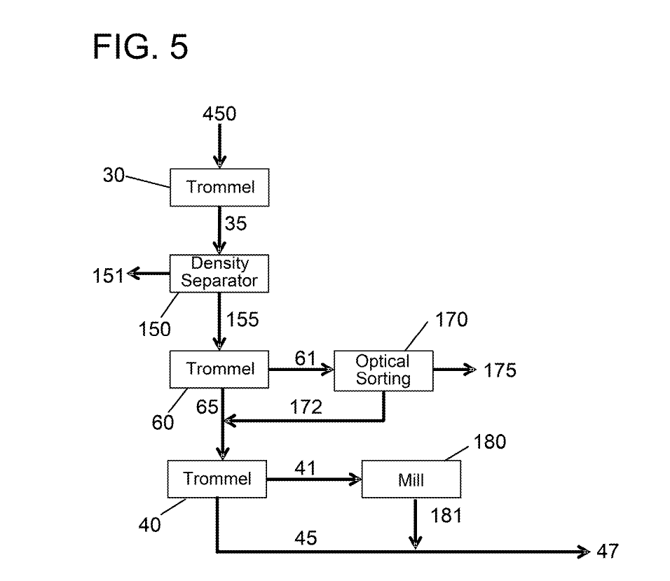

FIG. 5 depicts a fifth embodiment of the present disclosure wherein a mixed solid biowaste stream 450 is fractionated to form reject streams 31 and 151 enriched in inorganic material as compared solid biowaste stream 450, a recycle stream 175 enriched recyclable material as compared to mixed solid biowaste stream 450 and a clean biowaste stream 47. Fractionation of biowaste stream 450 through trommel 30 and density separator 150 to generate reject streams 31 and 151, oversize stream 35 and light material stream 155 generally proceeds according to the method depicted in FIG. 1 for processing biowaste stream 15. Light material stream 155 is fractionated in trommel 60 having openings of from about 50 mm to about 70 mm to form oversize stream 61 enriched in plastic as compared to light material stream 155 and an undersize stream 65 enriched in organic material as compared to light material stream 155. Oversize stream 61 is fractionated by optical sorting 170 to recover an organic rich stream 172 and a recycle stream 175 that is enriched in recyclable material. The organic rich stream 172 and the undersize stream 65 are fractionated in trommel 40 having openings of from about 20 mm to about 40 mm to form an oversize stream 41 and a cleaned biowaste undersize stream 45. The particle size of oversize stream 41 is reduced in mill 180 to form biowaste stream 181 that is combined with biowaste stream 45 to form cleaned biowaste stream 47 for conversion to monosaccharides and, optionally, fermentation products according to any of the various aspects of the present disclosure.

In any of the various aspects of the present disclosure, the mixed solid waste may be manually presorted and/or any of the various fractionated waste streams may be further processed by manual sorting to recover hazardous items and material, remove items that could damage the MSW sorting equipment and/or recover items that are large and have a high recovery value. Manual sorting may be done by personnel on one or more presorting lines such as by metering the waste onto a presorting conveyor where pre-sorted items are identified and removed. Examples of hand sorted items include electronic waste, structural steel, tires and rims, tanks containing compressed compounds (e.g., propane), concrete blocks, large rocks, pallets, cardboard, plasterboard, and the like. Further, hazardous waste such as containers of solvents and chemicals, paint cans and batteries are preferably removed before fractionation to avoid contamination with biowaste and other materials in the mixed waste.

In any of the various aspects of the present disclosure, mixed solid waste, optionally subjected to a manual presorting step, may be fractionated by size separation (e.g., screening) to form at least three sized waste streams comprising a first undersize stream enriched in biowaste as compared to the mixed solid waste, a second undersize stream enriched in rolling stock as compared to the mixed solid waste and an oversize stream enriched in paper and cardboard as compared to the mixed solid waste. Suitable screening devices include rotating trommels, disc screens, vibratory screens, and oscillating screens.

Typically, each size fractionation step is associated with a size cut-off wherein the fractionated particles are characterized by a distribution of particles. In the case of fractionation by size, the distribution often includes a number of particles or objects above or below a particular cut-off, such as a screen having a fixed opening size, such as 10 mm, 25 mm, 80 mm, 200 mm or 350 mm. Unless otherwise specified, a cut-off number (e.g., 80 mm) generally means that at least 75 wt. %, at least 80 wt. %, at least 85 wt. %, at least 90 wt. %, at least 95 wt. % or at least 99 wt. % of the particles or components have a size greater than the cut-off number (in the case of oversize) and at least 75 wt. %, at least 80 wt. %, at least 85 wt. % or at least 90 wt. %, at least 95 wt. % or at least 99 wt. % of the particles or components have a size less than the cut-off number (in the case of undersize). Alternatively stated, an average particle size refers to a particle size distribution wherein at least at least 75 wt. %, at least 80 wt. %, at least 85 wt. % or at least 90 wt. %, at least 95 wt. % or at least 99 wt. % of the particles or components pass through a screen having a specified opening size. In another size fractionation characterization, the sized waste streams may have a size distribution with a ratio of small particles to large particles, i.e., the ratio of the upper cut-off to the lower cut-off, of less than 25, less than 20, less than 15, less than 10, less than 8, less than 6, or less than 4. In the case of fractionation by density or spatial conformation (shape), the distribution often includes a number of particles or objects above or below a particular cut-off, i.e., density or shape (2-D or 3-D). Unless otherwise specified, a density cut-off number generally means that at least 50 wt. %, at least 60 wt. %, at least 70 wt. %, at least 80 wt. % or at least 90 wt. %, such as from about 60 wt. % to about 90 wt. % or from about 60 wt. % to about 75 wt. %, of the particles or components have a density greater than the cut-off number (in the case of oversize) and at least 50 wt. %, at least 60 wt. %, at least 70 wt. %, at least 80 wt. % or at least 90 wt. %, such as from about 60 wt. % to about 90 wt. % or from about 60 wt. % to about 75 wt. %, of the particles or components have a density less than the cut-off number (in the case of undersize).

In some aspects of the present disclosure, a first screen and a second screen are used in series to form at least three fractionated sized waste streams. In such aspects, the first screen opening size is about 60 mm, about 70 mm, about 80 mm, about 90 mm or about 100 mm, and ranges thereof, such as from about 60 mm to about 100 mm or from about 70 mm to about 90 mm. The second screen opening size is about 170 mm, about 180 mm, about 190 mm, about 200 mm, about 210 mm, about 220 mm, about 230 mm, about 240 mm, about 250 mm, about 260 mm, about 270 mm, about 280 mm, about 290 mm, about 300 mm, about 310 mm, about 320 mm, about 330 mm, about 340 mm, about 350 mm, about 360 mm, about 370 mm, or about 380 mm, and ranges thereof, such as from about 170 mm to about 380 mm or from about 200 mm to about 350 mm. In such aspects, first screen and second screen undersize streams and a second screen oversize stream are obtained.

In some other aspects of the present disclosure, the first screen described above is used in series with a second screen and a third screen to form at least four fractionated sized waste streams. The oversize from the first screen is fractionated with the second screen having openings of about 170 mm, about 180 mm, about 190 mm, about 200 mm, about 210 mm, about 220 mm, or about 230 mm, and ranges thereof, such as from about 170 mm to about 230 mm, or from about 190 mm to about 210 mm, to form a second undersize stream and a second oversize stream wherein (1) the second undersize stream is enriched in rolling stock as compared to the first oversize stream and (2) the second oversize stream is enriched in flat stock as compared to the second undersize stream. The second oversize stream is fractionated with the third having openings of about 320 mm, about 330 mm, about 340 mm, about 350 mm, about 360 mm, about 370 mm, or about 380 mm, and ranges thereof, such as from about 320 mm to about 380 mm, or from about 340 mm to about 360 mm, to form a third undersize stream and a third oversize stream wherein (1) the third undersize stream is enriched in bagged waste as compared to the third oversize stream and (2) the third oversize stream is enriched in flat stock as compared to the second oversize stream. In such aspects of the present disclosure, the third undersize waste is preferably processed in a bag opener to release the component contained therein prior to further fractionation.

In some aspects of disclosure, rotating trommel screens are used. A rotating trommel screen typically comprises a perforated cylindrical drum or a cylindrical framework retaining a perforated screen. The trommel may suitably be elevated at an angle at the feed end or discharge end, or may be non-elevated (i.e., flat). Size separation is achieved as the feed material spirals or otherwise moves down the rotating drum/screen, where the material smaller than the screen openings passes through the screen as an undersize fraction and the material larger than the screen opening is retained and moves forward as an oversize fraction. For the drum component, an internal screw may optionally be used when the placement of the drum is flat or elevated at an angle less than about 5°. The internal screw facilitates the movement of objects through the drum by forcing them to spiral. Any of the various trommel designs known in the art are suitable for the practice of the various aspects of the present disclosure. For instance, a trommel having two or more concentric screens with the coarsest screen located at the innermost section can be used. Alternatively, trommels can be arranged in series such that oversize and/or undersize material exiting a first trommel can be fed forward to a second trommel or a series of trommels. Still alternatively, a trommel having at least two sections of different opening sizes may be used, said trommel optionally arranged in series with one or more additional trommel as described above. The trommel screen may assume different configurations. The screens may suitably be perforated plates or mesh screens wherein the openings may be either square or round shape.

Screening optimization may be based on one or more of the following variables: (1) the required dimension of the undersized product, (2) the opening area wherein a square opening provides for a larger area than a round opening having the same diameter as the square opening length, (3) the degree of material agitation, (4) trommel rotation speed, (5) feed rate, (6) material residence time, (7) angle of drum inclination, (8) screen opening number and size, and (9) feed characteristics.

The undersize streams enriched in rolling stock are fractionated to separate the contained fines, 2-D components (e.g. paper and cardboard (“P&C”)) and 3-D components (e.g., rolling stock) thereby forming a fines stream, a rolling stock stream and a flat stock stream wherein the fines stream is enriched in biowaste as compared to the rolling stock stream and the flat stock stream, the rolling stock stream is enriched in plastic as compared to the fines stream and the rolling stock stream, and the flat stock stream enriched in P&C as compared to the fines stream and the rolling stock stream.

Fractionation of any of the various process streams, such as undersize streams, streams comprising an admixture of 2-D and 3-D objects, and/or streams comprising a heavy fines component, may be achieved by any of the various density separation techniques known in the art such as ballistic separators and air separators (e.g., windshifters and rotary air separators).

In some aspects of the present disclosure, fractionation of the undersize streams enriched in rolling stock is done by ballistic separation with screening. In general, ballistic separation with screening separates feedstock based on the characteristics of size, density and shape to form a first fraction comprising rolling objects (e.g. containers, plastic bottles, stones, cans and some metal objects), a second fraction comprising flat (planar) and light materials (e.g. films, textiles, paper and cardboard), and a screened, third, fines fraction (e.g., organic material, food and sand). Such ballistic separators generally comprise a ramp sloped upward from the feed end to the discharge end and further comprise a perforated conveyor. As the material is conveyed, rolling stock tumbles downward to the lowest elevation point at the feed end and forms the rolling stock fraction, fine elements pass through the screen and form the fines fraction, and flat and light density elements are conveyed to the discharge to form the flat stock stream. Air can optionally be blown from the feed end to the discharge end to improve the separation efficiency of the flat stock and rolling stock, and the conveyor can optionally be vibrated or oscillated to improve the fine stream separation efficiency.

Ballistic separation optimization may be based on one or more of the following variables: (1) the desired fines particle size, (2) the feed location on the belt, (3) feed rate, (4) material residence time, (5) angle of belt inclination, (6) screen opening number and size, (7) feed characteristics, (8) air speed and (9) degree of vibration or oscillation.

In some aspects of the present disclosure, the ballistic screen perforations (openings) openings may suitably be about 100 mm, about 90 mm, about 80 mm, about 70 mm, or about 60 mm, and ranges thereof, such as from about 60 mm to about 100 mm. The openings may suitably be of square or round shape. In some aspects of the present disclosure the opening size is about 80 mm, the fines are an 80 mm undersize stream characterized as having an organic content of at least 40 wt. %, at least 50 wt. % or at least 60 wt. %. The rolling stock stream is characterized by a glass component and a mixed plastics component comprising PET and HDPE. The rolling stock may further comprise mixed metals including aluminum, brass, copper, iron and steel. The flat stock stream is characterized by a P&C component. In some aspects, the flat stock stream is further characterized by a combustible, RDF, component having a heating value of at least about 15, 16 or 17 mega Joules per kilogram on a dry basis (about 7,500 Btu per pound).

In some aspects of the disclosure, the first undersize biowaste stream (i.e., the 60 mm to 100 mm first screen undersize material) is combined with the ballistic separation fines stream is enriched in biowaste separated from the rolling stock stream to form a combined crude biowaste stream. The crude biowaste stream is characterized by an organic content of at least 30 wt. %, and inorganic content of at least 20 wt. %, and lesser amounts of mixed plastic, paper, glass and mixed metal. The crude biowaste stream may be fractionated by various methods within the scope of the present disclosure as disclosed herein to form a cleaned biowaste stream for conversion to monosaccharides, an inorganic rich stream for disposal, and various plastic, glass, paper and metal streams for further fractionation.

In a first crude biowaste fractionating aspect of the present disclosure, the crude biowaste stream is fractionated with a screen as disclosed elsewhere herein and having a mesh size of from about 5 mm to about 15 mm, from about 8 mm to about 12 mm, or about 10 mm to form (i) an undersize stream having an inorganic content of at least 50 wt. %, at least 55 wt. %, or at least 60 wt. %, such as about 65 wt. % and an organic content of less than 50 wt. %, less than 45 wt. % or less than 40 wt. %, such as about 35 wt. % and (ii) an oversize crude biowaste stream having an organic content of at least 40 wt. %, at least 45 wt. %, at least 50 wt. %, at least 55 wt. % or at least 60 wt. % and having an average particle size of between about 5 mm and about 80 mm, between about 10 mm and about 80 mm, or between about 15 mm and about 80 mm, and further comprising a recyclable component comprising plastic. The inorganic-rich undersize stream may optionally be purged from the process.

In such aspects of the disclosure, the oversize crude biowaste stream may be processed by density separation to form a second dense reject stream and an intermediate biowaste stream. The second reject stream is enriched in inorganic compounds, glass and metal, and is of higher density in grams per cubic centimeter, as compared to the intermediate biowaste stream. The second reject stream may be purged from the process or may be further processed for recovery of contained metal, glass and/or organic compounds by any of various methods disclosed herein. Suitable density separation methods are known in the art and include, without limitation, air separators such as windshifters (available, for instance, from Nihot) and rotary air separators. Windshifters separate a feed stream into light and heavy fractions wherein light materials are separated from heavy materials in a separation unit by controlled airflow. The light materials are separated from the air stream in the separation unit and are conveyed out of the separation unit and the heavy fraction is retained in the separation unit. Separation efficiency varies with feed stream composition, but typically from about 70 wt. % to about 80 wt. % or from about 75 wt. % to about 85 wt. % of the inert material (e.g., inorganic material) is separated to the heavy fraction and at least 95 wt. % or at least 98 wt. % of the paper and cardboard is separated to the light fraction. Rotary air separation comprises an apparatus having a manifold opening through which air is drawn, the manifold being surrounded by a cylindrically shaped screen that rotates past the opening. The material to be separated is deposited on the screen in the area of the manifold opening, and the fine material is drawn through the screen as undersize (as permitted by the size of the screen openings) and conveyed by the air flow to a first collection point. The oversize material is drawn to the screen and is carried by the screen past the manifold opening to the opposite side of the separator where it is collected at a second collection point. Dense oversize material (such as gravel) is not conveyed by the screen but instead falls from the screen at the feed side of the apparatus and is collected at a third point.

In such aspects of the disclosure, the intermediate biowaste fraction is the light fraction, wherein the light fraction is fractionated with a screen as disclosed elsewhere herein and having a mesh size of from about 20 mm to about 30 mm, such as about 25 mm to form (i) a cleaned biowaste undersize stream having an organic content of at least at least 65 wt. %, at least 70 wt. %, at least 75 wt. % or at least 80 wt. %, such as from about 70 wt. % to about 85 wt. % or from about 70 wt. % to about 80 wt. % and having an average particle size of less than about 25 mm, and (ii) an oversize crude biowaste stream comprising organic material and enriched in recyclable material (e.g., paper, cardboard, metals, glass, plastic, and combinations thereof) as compared to the cleaned biowaste stream.

In such aspects of the disclosure, the oversize crude biowaste stream may be classified by optical sorting and/or X-ray sorting to recover a stream enriched in biowaste as compared to the oversize crude biowaste stream and a recovered stream enriched in plastics as compared to the oversize crude biowaste stream.

Optical sorters are known in the art and include, but are not limited to, Near Infrared (NIR) and camera color sorters. For example, in one embodiment the optical sorter can operate by scanning the intermediate waste stream in a free fall using a camera sensor. Other optical sorters utilize near infrared and other scanning technologies to separate targeted materials from mixed streams. In some aspects of the disclosure, mixed plastic streams may be sorted by plastic type on the basis of the principle of the reaction of the electrons in the material of the objects under analysis to infrared light, wherein the molecules in the object under analysis react to infrared light in an electron excitation pattern characteristic of the material composition. The infrared detector and associated computer read and interpret the pattern, assign a material type (e.g., HDPE, PET or PVC plastic) based on the interpretation, and classify (separate) the objects on a material type basis. In some aspects, a sensor (such as a camera or light sensor) detects a signal characteristic of the material to be separated and transmits detection signals to a computer system wherein the signals are analyzed by an algorithm executing within a computer system to determine relative composition or identity of the material with respect to a preset relative composition or value. The computer system transmits an output signal to actuate air jets to quickly eject the material while in free fall. Any number of optical sorters can be used in series or parallel. Manufacturers of optical sorters include TiTech Pellenc, MSS, NRT, and others.

X-ray sorting systems are based on measuring the X-ray absorptions in a material at differing energy levels in order to determine the relative atomic density of the material. More particularly, X-ray absorption in a material is a function of the atomic density of the material and also a function of the energy of the incident X-rays wherein a given piece of material will absorb X-rays to differing degrees depending upon the energy of the incident X-rays. In some aspects, an X-ray sensor detects a signal characteristic of the material to be separated and transmits detection signals to a computer system wherein the signals are analyzed by an algorithm executing within a computer system to determine relative composition or identity of the material with respect to a preset relative composition or value. The computer system transmits an output signal to actuate air jets to quickly eject the material while in free fall. This technology can evaluate the entire object and looks through the entire object taking into consideration exterior and interior variations. Such sorting systems are disclosed in U.S. Pat. No. 7,564,943 and are commercially available, such as from National Recovery Technologies, LLC of Nashville, Tenn. X-ray sorters may be used in combination with optical sorters.

In some X-ray absorption sorting systems, a dual energy x-ray detector array is positioned below the surface of a conveyor belt used for transporting mixed waste into and through a sensing region located between a detector array and an X-ray tube. Suitable detector arrays may be obtained from Elekon Industries (Torrance, Calif.) and X-ray tubes may be obtained from Lohmann X-ray (Leverkusan, Germany). The X-ray tube is preferably a broadband source that radiates a sheet of preferably collimated X-rays across the width of the conveyor belt along the dual energy X-ray detector array such that X-rays pass through sensing region and the conveyor belt prior to striking the detectors. As material passes through the X-rays sensing region, X-rays transmitted through them are detected by the dual energy x-ray detector array at two different energy levels. The detection signals are transmitted to a computer system and the signals are analyzed by an algorithm executing within a computer system to determine relative composition of the material with respect to a preset relative composition. An array of high speed air ejectors is positioned downstream from the sensing region and positioned across the width of the trajectory paths of materials discharged off the end of conveyor belt. The materials classification and sorting algorithm executes within the computer system and, according to results derived through executing of algorithm, the computer system signals selected air ejectors within air ejector array to energize and thereby eject the selected materials from the flow of materials according to computed relative composition. The sequence of sensing, selection, and ejection can happen simultaneously in multiple paths along the width of the conveyor belt so that multiple material samples can be analyzed and sorted coincidentally.

Optical sorting systems and X-ray sorting systems may be configured to scan a mixed waste stream and determine whether the material being analyzed is a particular type of material such as plastic, paper, or glass, and recover (i) HDPE plastic, PET plastic, #3-7 plastics and/or polyvinyl chloride (PVC) plastics, (ii) glass and/or (iii) paper from a mixed waste stream comprising organic particles and/or inorganic particles. Optical sorting systems and X-ray sorting systems may further be configured to distinguish between plastic types, such as HDPE plastic, PET plastic and PVC plastic such that a stream containing mixed plastic can be sorted into streams based on plastic type. For instance, upon detection of a particular material in a mixed waste stream, an optical sorting system or X-ray sorting system may use air directed through nozzles to eject the targeted/identified material to produce one or more recycled products such as recyclable PET, recyclable HDPE, recyclable film plastic, recyclable #3-7 plastic, recyclable glass and/or recyclable paper products.

More particularly, for instance, mixed waste may be loaded onto a conveyor, the speed of which is selected so that the mixed waste is launched out over the end of conveyor. The optical sensor or X-ray system is programmed via software in a computer system to detect the shape, type of material, color or levels of translucence of particular objects. For example, the computer system connected to the optical sensor or X-ray system may be programmed to detect the type of plastic material associated with plastic bottles, such as PET, HDPE, and PVC. Objects having the preprogrammed material characteristics are detected by the optical sensor or X-ray system when passing through a light beam or X-ray filed and the computer system connected to the sensor sends a signal activating a high pressure ejection air nozzle. The ejection air nozzle releases a blast of air that knocks the detected objects downward out of normal trajectory path into a first bin and/or on to a first conveyor. Other material and objects continue to travel along trajectory path into a second bin and/or on to a second conveyor. In some aspects of the present disclosure, any of the various streams generated in a first optical/X-ray sorting system may optionally be processed in at least one additional optical and/or X-ray sorting system to produce any one of a plastic stream sorted by type (e.g., PET, HDPE or PCV), glass sorted by color, paper. The remainder of the waste stream from the one or more optical/X-ray sorters is typically an organic-rich particulate stream.

In such aspects of the disclosure, the stream enriched in biowaste recovered by optical/X-ray sorting of the oversize crude biowaste stream typically has an average particle size of between about 25 mm and about 80 mm. The average particle size of said stream is preferably reduced to less than about 25 mm in order to maximize the surface area to weight ratio in order to increase the efficiency of hydrolysis to glucose. Any suitable milling device can be used, such as a grinder, hammer mill, crusher, knife mill, chopper, disc mill, a centrifugal mill or a homogenizer. The milled recovered biowaste stream is combined with the cleaned biowaste stream and thereafter converted to glucose by hydrolysis.

In a second crude biowaste fractionating aspect of the present disclosure, the crude biowaste stream is fractionated with a screen as disclosed elsewhere herein and having a mesh size of from about 25 mm to about 50 mm to form (i) a primary undersize stream having an inorganic content of from about 20 wt. % to about 40 wt. % or from about 25 wt. % to about 35 wt. % on a dry basis and (ii) a primary oversize crude biowaste stream having an organic content of from about 60 wt. % to about 80 wt. % or from about 65 wt. % to about 75 wt. % on a dry basis, and having an average particle size of between about 25 mm and about 80 mm, between about 30 mm and about 80 mm, between about 35 mm and about 80 mm, between about 40 mm and about 80 mm, between about 45 mm and about 80 mm, or between about 50 mm and about 80 mm, and further comprising recyclable material.

In such aspects, the primary undersize stream is fractionated with a screen as disclosed elsewhere herein and having a mesh size of from about 5 mm to about 15 mm, from about 8 mm to about 12 mm, or about 10 mm to form (i) an undersize stream having an inorganic content of from about 60 wt. % to about 80 wt. % or from about 65 wt. % to about 75 wt. % on a dry basis and an organic content of from about 20 wt. % to about 40 wt. % or from about 25 wt. % to about 35 wt. % and (ii) an oversize crude biowaste stream having an organic content of from about 65 wt. % to about 90 wt. %, or from about 70 wt. % to about 90 wt. % on a dry basis and having an average particle size of between about 5 mm and about 50 mm, between about 5 mm and about 25 mm, between about 10 mm and about 50 mm, between about 10 mm and about 25 mm, between about 15 mm and about 50 mm, or between about 15 mm and about 25 mm. The inorganic-rich undersize stream may be purged from the process.

In such aspects, the oversize crude biowaste stream and the primary oversize crude biowaste stream are fractionated by optical or X-ray sorting to generate at least three streams. In some aspects of the present disclosure, X-ray sorting is utilized. Two organic rich streams are formed wherein a first stream has an average particle size of less than 25 mm and a second stream has an average particle size of greater than 25 mm. The particle size of the second stream is reduced to less than 25 mm in a mill as described elsewhere herein and the first stream and milled second stream are combined to form a cleaned biowaste stream for conversion to monosaccharides, said stream having an organic content of from about 70 wt. % to about 90 wt. % or from about 75 wt. % to about 90 wt. %. A third stream generated by optical sorting is enriched in recyclable material as compared to the cleaned biowaste stream. The third stream may be optionally purged from the process or further fractionated such as by optical/X-ray sorting, density separation, or a combination thereof, to recover the contained components for recycle or further processing.

In some second crude biowaste fractionating aspects of the present disclosure, a crude biowaste stream is fractionated in a two-stage screening scheme through a first screen having openings of from about 20 mm to about 30 mm, such as about 25 mm, and through a second screen having openings of from about 40 mm to about 60 mm, such as about 50 mm, to form a first undersize stream that passes through the 20 mm to 30 mm openings, a second undersize stream that passes through the 40 mm to 60 mm openings and an oversize stream wherein the first undersize stream is enriched in inorganic compounds as compared to the second undersize stream. The first undersize stream is fractionated in trommel having openings of from about 5 mm to about 15 mm, such as about 10 mm to form an undersize stream predominantly comprising inorganic material and an oversize stream enriched in organic material such as cellulose, hemicellulose and starch, as compared to the undersize stream. The −5 mm to −15 mm undersize stream may optionally be purged from the process as landfill or may be further process to fractionate and remove various components. The +5 mm to +15 mm oversize stream is processed in a first X-ray separation step to form a first X-ray separation reject stream enriched in inorganic components and a first cleaned biowaste stream enriched in organic components where the first cleaned biowaste stream is characterized by an average particle size of from about 5 mm to about 30 mm or from about 10 mm to about 25 mm. The second undersize stream that was passed through a screen having openings of from about 40 mm to about 60 mm is processed in a second X-ray separation step to form a second X-ray separation reject stream enriched in inorganic components and a second cleaned biowaste stream enriched in organic components where the second cleaned biowaste stream is characterized by an average particle size of from about 20 mm to about 60 mm or from about 25 mm to about 50 mm. In a first option, the oversize stream from the screen having openings of from about 40 mm to about 60 mm is processed in a third X-ray separation step to form a third X-ray separation reject stream enriched in inorganic components and a third cleaned biowaste stream enriched in organic components where the third cleaned biowaste stream is characterized by an average particle size of from about 40 mm to about 100 mm or from about 50 mm to about 80 mm. In a second option, the oversize stream from the screen having openings of from about 40 mm to about 60 mm is processed by optical sorting to form a recycle stream enriched in plastic that is further processed, such as by co-processing with the rolling stock stream in an optical sorting step, and an optical sorting biowaste stream enriched in organic components. The optical sorting biowaste stream may then be processed in a third X-ray separation step as described herein. The second and third cleaned biowaste streams are co-comminuted to reduce the average particle size to less than about 25 mm and are then combined with the first cleaned biowaste stream to form cleaned biowaste for conversion to monosaccharides. Any of the first, second and third X-ray separation reject streams may be optionally purged from the process or further fractionated such as by optical sorting, by density separation, or a combination thereof.

In a third crude biowaste fractionating aspect of the present disclosure, the third stream (enriched in recyclable material as compared to a cleaned biowaste stream) generated by optical or X-ray sorting described above in connection with the second aspect of the present disclosure, is further fractionated by optical sorting to recover streams comprising an organic rich stream and a recycle stream that is enriched in recyclable material. In some third aspect embodiments, paper, cardboard, glass, metals and/or plastic may be recovered as individual fractions or streams. The organic rich stream is characterized by a particle size greater than 25 mm, such as from about 25 mm to about 80 mm. That stream is preferably milled as described elsewhere herein to reduce the particle size to less than 25 mm. The milled or un-milled stream is then combined with the cleaned biowaste stream for conversion to monosaccharides. The stream enriched in recyclable material, or individual fractions thereof, are forwarded to ballistic separation rolling stock fractionation by optical sorting and hand sorting as described elsewhere herein for the recovery or purification of plastics, metals, glass, paper and cardboard.

In a fourth crude biowaste fractionating aspect of the present disclosure, (i) the crude biowaste stream is fractionated with a screen having a mesh size of from about 5 mm to about 15 mm to form an undersize stream and an oversize crude biowaste stream and (ii) the oversize crude biowaste stream is fractionated by density separation to form a second dense reject stream and an intermediate biowaste stream as described herein in connection with the first crude biowaste fractionating aspect of the present disclosure. The intermediate biowaste stream is fractionated with a screen having a mesh size of from about 50 mm to about 70 mm, such as about 60 mm, to form a second oversize stream and a second undersize stream wherein the second oversize stream is enriched in recyclable material as compared to the second undersize stream and the second undersize stream is enriched in biowaste as compared to the second oversize stream. The second oversize stream is fractionated by optical sorting and/or X-ray sorting to remove and recover an organic rich stream from the second oversize stream. Recycle product streams comprising plastics, metals, glass, paper and/or cardboard may be generated by optical sorting and/or X-ray sorting, or the cleaned second oversize stream (or fractions thereof) may be forwarded to ballistic separation rolling stock fractionation by optical sorting and hand sorting as described elsewhere herein for the recovery or purification of plastics, metals, glass, paper and cardboard. In some aspects of the present disclosure, optical sorting is utilized.

The biowaste-rich second undersize stream (having an average particle size of greater than about 60 mm) is combined with the second undersize stream (having an average particle size of less than about 70 mm) to form a biowaste stream having an organic content of at least 50 wt. %, at least 55 wt. %, at least 60 wt. %, or at least 65 wt. %, such as about 60 wt. %. The combined streams are fractionated with a screen having a mesh size of from about 20 mm to about 30 mm, such as about 25 mm, to form a cleaned biowaste undersize stream and an oversize stream. The oversize stream is preferably milled as disclosed elsewhere herein to form a milled biowaste stream having a particle size of less than about 25 mm. The milled biowaste stream is combined with the cleaned biowaste stream for conversion to monosaccharides.

In any of the various aspects of the present disclosure, the cleaned biowaste stream comprises an organic content of from about 70 wt. % to about 90 wt. % or from about 75 wt. % to about 90 wt. %. The cleaned biowaste stream comprises from a soluble organic component and an insoluble organic component. The soluble organic component comprises from about 2 wt. % to about 10 wt. %, or from about 2 wt. % to about 5 wt. % glucan and from about 0.05 wt. % to about 1 wt. % xylan. The insoluble component comprises from about 5 wt. % to about 20 wt. % or from about 8 wt. % to about 20 wt. % glucan, from about 1 wt. % to about 10 wt. % or from about 2 wt. % to about 5 wt. % xylan, from about 20 wt. % to about 40 wt. % or from about 25 wt. % to about 35 wt. % cellulose and from about 5 wt. % to about 15 wt. % lignocellulose. The cleaned biowaste further comprises less than about 40 wt. %, less than about 35 wt. %, less than about 30 wt. %, less than about 25 wt. %, less than about 20 wt. % or less than about 15 wt. % ash (inorganics).

In any of the various aspects of the present disclosure, the rolling stock stream is fractionated by optical sorting and/or X-ray separation as described elsewhere herein, optionally in further combination with at least one hand sorting step, to isolate a number of recycle streams including a plastic film stream, a HDPE stream, a PET stream, and a mixed plastics stream. Other possible recycle streams generated in rolling stock stream fractionated may include glass streams sorted by color, a PVC plastic stream, a mixed glass stream, a mixed metal stream, metal streams sorted by alloy (e.g., aluminum, brass and copper), a beverage carton stream, a paper stream and/or a cardboard stream. The residual material remaining after rolling stock stream fractionation is enriched in combustible material as compared to the various recovered streams and is forwarded to RDF conditioning as described elsewhere herein.

In some aspects of the present disclosure, the flat stock stream generated by 2-D/3-D fractionation (e.g., ballistic separation) of the undersize stream(s) enriched in rolling stock may optionally be sorted by optical sorting as described elsewhere herein to form a recovered P&C stream and a RDF-rich stream. The RDF-rich stream is forwarded to RDF conditioning as described elsewhere herein. The P&C stream may optionally be sold or processed to recover cellulosic fiber for conversion to monosaccharides.

In some aspects of the present disclosure, the flat stock stream comprising P&C generated by 2-D/3-D fractionation (e.g., ballistic separation) of the undersize stream(s) enriched in rolling stock may optionally be processed in a sequential batch reactor (“SBR”) for recovery of a cellulosic fiber stream for conversion to monosaccharides by hydrolysis of cellulosic materials and a RDF-rich stream. SBRs within the scope of the disclosure include an inclined rotating cylinder with direct steam injection and having internal flights or other means known in the art to induce mixing and homogenation of tumbling material. The flat stock stream is introduce to the SBR and contacted with steam to raise the temperature to about 40° C., 50° C., 60° C., 70° C., 80° C. or 90° C., and ranges thereof, such as from about 40° C. to about 80° C., to initiate digestion and/or hydrolysis of the cellulosic material, and to reduce the particle size. Optimization may be based on one or more of the following variables: (1) feed characteristics, (2) temperature, (3) feed rate and residence time, (4) angle of inclination, (5) degree of tumbling, and (6) rotation speed.

In such aspects of the present disclosure, the SBR discharge stream is fractionated with a screen as described elsewhere herein and having a mesh size of from about 5 mm to about 15 mm, such as about 10 mm, to form a SBR oversize stream comprising RDF and a SBR undersize stream enriched in cellulosic compounds (cellulose and lesser amounts of hemicellulose and lignocellulose) and inorganic compounds such as paper fillers. Paper fillers are compounds that typically are added to paper in concentrations of up to about 50% by weight (“wt. %) to impart softness, flexibility, and optical properties such as opacity and color and generally include inorganic compounds and pigments such as clay (e.g., kaolin clay), calcium carbonate and other calcium containing components, ink particles, titanium dioxide, talcum, magnesium-containing components, sodium-containing components, potassium-containing components, silicon-containing components, phosphorus-containing components and aluminum containing components (collectively termed “ash”). Problematically, paper fillers such as calcium carbonate reduce the bioavailability of cellulosic compounds and kaolin clays reduce the activity of cellulolytic and hemicellulolytic enzymes. Therefore, in some aspects of the present disclosure, the SBR undersize stream is fractionated to remove contaminants and form a purified cellulosic stream for conversion to monosaccharides.

In one such purification fractionation aspect, a SBR undersize slurry is formed comprising from about 2 to about 8 percent by weight total solids including cellulosic material and paper fillers. The slurry is pulped under shearing conditions to form a pulped slurry comprising cellulosic fiber and released contaminants (paper fillers). Suitable pulping systems and methods are known in the art. The pulped slurry is fractionated through a filtration medium having opening of from about 0.2 cm to about 1.5 cm to form an oversize stream comprising coarse contaminants and an undersize stream comprising cellulosic fibers and light contaminants. The undersize stream may be subjected to pretreatment as described elsewhere herein to hydrolyze at least a portion of the cellulose component to monosaccharides. In some optional aspects, the undersize stream may be further purified by separating at least a portion of the light contaminants from the cellulosic fiber, such as by washing on a filtration medium or in a centrifuge, to form a light contaminant stream comprising ash and a cellulosic fiber stream. Typically, purified undersize streams enriched in cellulose comprise no more than about 15 percent by weight ash on a dry basis, and wherein the ash content of the cellulosic fiber stream is less than the ash content of the SBR undersize stream on a dry basis. In any of the various such aspects, the cellulosic fiber stream is dewatered (thereby removing further light contaminants) to form a dewatered cellulosic fiber stream having a solids content of from about 25 wt. % to about 60 wt. % and an aqueous stream. In some optional aspects, contaminant separation and removal (such as by dissolution) may be enhanced by (i) adding acid to the pulping slurry to adjust the pH to from about 2 to about 6 or (ii) adding base to the pulping slurry to adjust the pH to from about 8 to about 12. The dewatered cellulosic fiber stream may be converted to glucose, alone or in combination with cleaned biowaste.

In another such aspect, the SBR undersize stream is dry fractionated by screening to remove a fine particulate fraction enriched in ash and form a cleaned solid biowaste-rich stream enriched in cellulosic compounds. Generally, the SBR is fractionated by at least one classifying screen as described elsewhere herein to recover the cleaned solid biowaste-rich stream on the at least one classifying screen wherein the fine particulate fraction passes through the screen. In some aspects of the present disclosure, the screen separation system includes one screen having openings of about 0.1 mm, about 1 mm, about 2 mm, about 3 mm, about 4 mm about 5 mm, about 6 mm, and ranges thereof, such as from about 0.1 mm to about 6 mm, from about 0.5 mm to about 2 mm, or from about 0.5 mm to about 1.5 mm. In various other aspects, the screen separation system comprises two screens, such as a first screen having openings of from about 3 mm to about 8 mm or from about 3 mm to about 6 mm and a second screen having openings of from about 0.5 mm to about 2 mm or from about 0.5 mm to about 1.5 mm. The fine particulate fraction typically comprises an inorganic (ash) content of at least 50 wt. %, at least 75 wt. %, at least 80 wt. %, at least 90 wt. %, or up to about 95 wt. %, such as from about 50 wt. % to about 95 wt. % or from about 80 wt. % to about 95 wt. % and the ratio of the ash content in the fine particulate fraction to the ash content of the cleaned solid biowaste-rich stream is at least 2:1, at least 3:1, at least 4:1 or at least 5:1. In some other aspects of the present disclosure, removal of an inorganic-rich fraction from the SBR undersize can be done by rotary air classification methods known in the art such as described in U.S. Pat. Nos. 1,629,594, 3,734,287 and 4,869,786, incorporated by reference herein, or by one or more vibrating screens wherein the inorganic-rich fraction forms a fines fraction and the biowaste-rich stream is a coarse fraction.

Any of the various RDF streams within the scope of the present disclosure may be conditioned to form SRF. In accordance with one aspect of the present disclosure, the various RDF fuels are combined and processed in a primary shredder to reduce the bulk. A typical average particle size is from about 200 mm to about 350 mm. Suitable shredders include, without limitation, industrial strip-cut paper shredders or cardboard shredders including shredders having one or more shafts that including a number of cutting heads that that can cut and/or shred incoming waste materials to a selected size. An example of a shredder is a counter-rotating screw shredder (available from Munson (Utica, N.Y.)). The shredded material is fractionated by air classification as described herein (such as by a windshifter) to form a light stream and a heavy stream wherein the light stream is enriched in combustible material as compared to the heavy stream. The light stream is processed in a secondary shredder to further reduce the bulk and particle size and form SRF. A typical average particle size is from about 20 mm to about 50 mm. The SRF may optionally be dried to increase the energy value per unit weight. SRF is characterized as having a caloric value of between about 17 and about 30 mega joules per kilogram (from about 7,500 to about 13,000 Btu/lb) and less than about 20 wt. % water. SRF within the scope of the present disclosure may suitably be used as an energy source for boilers and cement kilns, or as a gasification substrate.

In any of the various aspects of the present disclosure, one or more magnetic separation devices can be used at various points in the systems of the present disclosure to collect ferrous metal. Examples of magnetic separators include drum magnets, cross-belt magnets, head pulley magnets, and the like. Suitable locations include, without limitation, trommel undersize and oversize outlets and conveying systems, density separation heavy stream outlets and conveying systems, and in combination with optical sorting and X-ray sorting systems.

In any of the various aspects of present disclosure, one or more electrostatic separators for the isolation and separation of plastic components may be operated in conjunction with one or more other systems disclosed herein, including air fractionators, fractionation screens, material transfer and conveying systems, optical and X-ray sorters, and bag openers. Electrostatic separation systems are known in the art and are available commercially. In some aspects of the disclosure, separation of plastics based on type may be done by electrostatic separation wherein a stream comprising mixed plastics is electrostatically charged (such as by friction or by application of a charge) resulting in positively and negatively charged material, wherein PE, PVC and PET plastics have a characteristic, and different, induced charge. For instance, PE and PET typically assume a positive charge and PVC typically assumes a negative charge. The positively and negatively charge materials are passed through an electrostatic field formed by counter electrodes at opposite sides wherein the positively charged plastic migrates to the negative electrode side and the negatively charge plastic migrates to the positive electrode side resulting in separation of plastic by type. Electrostatic separation systems are available from Hitachi Zosen Corporation.

The cleaned biowaste and cellulosic fiber streams may be converted by one or more hydrolysis steps to an aqueous stream comprising glucose. In some aspects of the present disclosure, the glucose stream may be concentrated to form a glucose syrup. In some optional aspects, the glucose stream may be purified to remove impurities and C5 monosaccharides (e.g., xylose). In some other aspects of the present disclosure, the glucose stream may be contacted with a source of at least one fermentation organism to form a fermentation product.

In some biowaste conversion aspects of the present disclosure, the cleaned biowaste is combined, or impregnated, with at least one aqueous stream with agitation to form a cleaned biowaste slurry having a water content of about 50 wt.%, about 60 wt. %, about 70 wt. %, about 80 wt. %, or about 90 wt. %, and ranges thereof, such as from about 50 to about 90 wt. % or from about 60 to about 80 wt. %. The pH may optionally be adjusted to about 1, 2, 3, 4, 5 or 6, and ranges thereof, such as from about 1 to about 6, from about 2 to about 6, or from about 3 to about 5 in order to favor solubilization of at least a portion of the starch, dextrin, disaccharides and/or monosaccharides contained in the biowaste and to provide conditions favorable for cellulose, hemicellulose and lignocellulose hydrolysis and/or to sterilize the slurry. As used herein, dextrin refers to low molecular weight mixtures of glucose polymers produced by starch hydrolysis and linked by α-1,4 and α-1,6 bonds. In some other aspects, the acid concentration is adjusted to from about 0.01 to about 0.05 kg acid per kg cleaned biowaste on a solids basis. Mineral acids (e.g., sulfuric acid and hydrochloric acid) or organic acids may be used, and mineral acids are generally preferred. Alternatively, the pH may optionally be adjusted to about 8, 9, 10, 11, or 12, and ranges thereof, such as from about 8 to about 12, from about 9 to about 11. In some other aspects, the base is ammonia and the ammonia concentration is adjusted to from about 0.1 to about 0.5 kg per kg cleaned biowaste on a solids basis. The temperature may optionally be adjusted to about 30° C., about 40° C., about 50° C., about 60° C., about 70° C. or about 80° C., and ranges thereof, such as from about 30° C. to about 80° C. or from about 40° C. to about 60° C.

Cleaned biowaste impregnation may be done by any suitable means known in the art. In one method, cleaned biowaste is sprayed with water (optionally comprising acid or base) with mixing in a high shear mixer, such as a ribbon blender or a pug mill. The impregnated material is typically held for a sufficient period of time prior to steam pretreatment to allow for moisture and temperature equilibration, such as about 5 minutes, 15 minutes, 30 minutes, 45 minutes or an hour. In another method, a slurry comprising cleaned biowaste water (optionally comprising acid or base) is formed with mixing at a moisture content of at least about 60 wt. %, such as from about 70 wt. % to about 90 wt. %. The slurry is then dewatered to yield the moisture impregnated cleaned biowaste. In any of the various aspects, the final moisture content of the impregnated cleaned biowaste is from about 20 wt. % to about 80 wt. %, 30 wt. % to about 70 wt. %, or from 30 wt. % to about 60 wt.%.

In some aspects, the biowaste slurry or pH-adjusted biowaste slurry is processed by at least one solid-liquid separation step to form a liquid stream comprising soluble biowaste components (e.g., monosaccharides, disaccharides, dextrins and soluble starch) and a solid biomass stream comprising insoluble biowaste components (e.g., cellulose, hemicellulose, lignocellulose, minor amounts of dextrin and insoluble starch). Any solid-liquid separation technique known in the art, such as filtration or centrifugation, is suitable for the practice of the present disclosure.

In any of the various cleaned biowaste hydrolysis aspects of the disclosure, the solid biomass stream (optionally impregnated with water, acid or base) may optionally be contacted with steam at elevated temperature and pressure followed by rapid depressurization in a steam pretreatment step to enhance the accessibility of the cellulosic components to enzymes. More particularly, the solid biomass stream may be subjected to elevated pressure and temperature conditions to break down the cellulose-hemicellulose and cellulose-hemicellulose-lignin complexes. After a period of contact time, the pressure of the solid biomass stream is reduced and/or the treated feedstock is discharged to an environment of reduced pressure, such as atmospheric pressure, to generate steam treated solid biomass stream and flash and vent steam. The change in pressure results in rapid material expansion thereby assisting in breaking down the biomass fiber structure including, for example, the bonds between lignin (if present) and hemicellulose and/or cellulose in the cellulose-hemicellulose or cellulose-hemicellulose-lignin complex (collectively termed “cellulose complexes”). More particularly, by physio-chemical means, steam treatment typically dissociates cellulose from hemicellulose and lignin (if present) thereby providing cellulose suitable for enzymatic hydrolysis to glucose. Steam treatment also typically dissociates hemicellulose from the complex, generally in the form of hemicellulose solubilized within a liquid phase of the treated cellulosic biomass. In various aspects, from about 10 wt. % to about 20 wt. % of the hemicellulose contained in the cellulosic biomass is solubilized within a liquid phase of the treated cellulosic biomass. In this manner, steam treatment provides hemicellulose suitable for enzymatic hydrolysis to monosaccharides. The solid biomass stream for steam pretreatment may be of neutral pH or may be of acidic or basic pH as described above. Alternatively, the solid biomass stream may be impregnated with additional acid or base prior to steam pretreatment. Acid or base impregnation may done by any means known in the art to achieve a substantially homogeneous admixture, including agitated mixing tanks (followed by a dewatering step), in line mixers, pug mill mixers, paddle mixers, ribbon mixers. In any of the various aspects, the solid biomass or impregnated biomass is contacted with steam at a temperature of from about 150° C. to about 250° C., from about 150° C. to about 220° C., from about 175° C. to about 220° C., or from about from about 175° C. to about 200° C. from about and at a pressure of from about 400 kPa gauge to about 1750 kPa, from about 500 kPa gauge to about 1525 kPa, from about 625 kPa gauge to about 1450 kPa, or from about 1000 kPa gauge to about 1400 kPa. Total elevated temperature and pressure contact time is from about 1 minute to about 60 minutes, from about 1 minute to about 30 minutes, from about 1 minute to about 10 minutes, or from about 2 minutes to about 6 minutes. In some aspects of the disclosure, the pressure is about 600 kPa and the contact time is about 8 minutes. In some aspects of the disclosure, after the contact time has elapsed, the pressure is reduced to less than about 35 kPa, such as about 30 kPa, about 25 kPa, about 20 kPa, about 15 kPa, about 10 kPa, about 5 kPa, slightly above ambient pressure, or about ambient pressure to form the steam pretreated insoluble biomass (i) in a single pressure reduction step or (ii) the pressure is reduced to from about 345 kPa to about 1380 kPa, from about 345 kPa to about 1205 kPa, from about 690 kPa to about 1380 kPa, from about 690 kPa to about 1205 kPa, from about 690 kPa to about 1035 kPa, or from about 1035 kPa to about 1205 kPa in a first pressure reduction step and held for a period of time from about 0.5 minutes to about 30 minutes, from about 0.5 minutes to about 15 minutes, or from about 1 minute to about 5 minutes, followed by reduction to less than about 35 kPa in a second step.

In some aspects of the present disclosure, solid biomass stream (optionally impregnated with acid or base) is introduced into a vessel comprising a contact zone for steam treatment. The solid biomass stream is typically in the form of a slurry, or cake. For example, the solid biomass stream may be pressed to form a cake, or plug of treated solids for introduction into the steam treatment vessel. The precise form and configuration of the vessel is not narrowly critical and may be selected by one skilled in the art depending on the particular circumstances (e.g., properties of the cellulosic biomass and operating conditions). Generally, the vessel includes an inlet for introduction of the solid biomass stream and one or more outlets for releasing treated cellulosic biomass and/or various components generated during the steam treatment. Once the solid biomass stream is contained in the vessel, the vessel is pressurized and the solid biomass stream is heated by direct steam injection. In any of the various steam pretreatment aspects of the disclosure, a vapor or gas stream may be continuously or periodically vented from the steam pretreatment vessel to purge volatile organic compounds (“VOCs”) generated as byproducts of cellulose, hemicellulose and lingo-cellulose acid and steam treatment that are known to be enzymatic and/or fermentation inhibitor compounds. Such inhibitors include, for instance, acetic acid, furfural and hydroxymethylfurfural (“HMF”). In some other optional aspects of the disclosure, solid biomass stream heating can additionally be done indirectly, such as by applying steam to a vessel jacket. Typically, the solid biomass stream is maintained at a target temperature and pressure, such as by pressure control, for a time sufficient to provide suitable heating. In some aspects of the present disclosure, after a period of pressurizing the vessel and heating the solid biomass stream, the solid biomass stream is released or transferred from the contact vessel to a receiving vessel having reduced and controlled pressure. In some other aspects of the present disclosure, after a period of pressurizing the vessel and heating the solid biowaste stream, the pressure and temperature in the vessel is reduced to an intermediate pressure and temperature and held for a period of time at those conditions, followed by pressure reduction to atmospheric pressure or a pressure slightly above atmospheric pressure. In yet some other aspects of the present disclosure, after a period of pressurizing the vessel and heating the solid biomass stream, the pressure and temperature in the vessel is reduced to atmospheric pressure or a pressure slightly above atmospheric pressure. In any of the various aspects of the present disclosure, as noted, the abrupt decrease in pressure during this release promotes break down of the cellulose complex. That is, the abrupt decrease in pressure causes a rapid increase in volume of the steam and gases trapped inside the biomass pore structure resulting in high rapid incident gas velocities and/or rapid vaporization of heated water that has either occupied or been forced into the fiber structure. In cases where the pressure differential is sufficiently high and wherein the pressure change occurs rapidly, the concomitant rapid vaporization and gas velocity occur essentially instantaneously in a method known in the art as steam explosion. In any of the various aspects of the present disclosure, the depressurization step generates flash steam comprising various VOCs as describe above”).

The steam pretreated solid biomass stream is combined with (1) the liquid stream comprising soluble biowaste components and/or an aqueous stream and (2) a source of enzymes comprising at least cellulase to generate a hydrolyzate comprising glucose. Cellulases are a class of enzymes produced chiefly by fungi, bacteria, and protozoans that catalyze the cellulolysis (hydrolysis) of cellulose into glucose, cellobiose, cellotriose, cellotetrose, cellopentose, cellohexose, and longer chain cellodextrins. Combinations of the three basic types of cellulases may be employed. For example, endo-cellulases may be added to randomly hydrolyze interna β-1,4-D-glucosidic linkages in order to disrupt the crystalline structure of cellulose and expose individual cellulose chains. Exo-cellulases may be added to cleave off two units (cellobiose), three units (cellotriose), or four units (cellotetrose) from the exposed chains, while β-glucosidase may be added to hydrolyze these compounds into glucose, which is available for fermentation. Examples of suitable cellulases include, for example, Cellic® CTec2, Cellic® CTec3, CELLUCLAST®, CELLUZYME®, CEREFLO® and ULTRAFLO® (available from Novozymes A/S), LAMINEX®, SPEZYME®CP (Genencor Int.), and ROHAMENT® 7069 W (Rohm GmbH), and GC-220 (Genencor International). The liquid stream is preferably sterilized to kill microbes prior to combination with the steam pretreated solid biomass stream. Sterilization may be done by, for instance, temperature treatment, UV radiation, or a combination thereof.

In any of the various aspects, in general, a slurry is formed from the liquid and pretreated solid biomass streams at conditions favorable for cellulase activity. More particularly, the slurry pH is preferably adjusted to from about 4 to about 6.5, from about 4.5 to about 6, or from about 5 to about 5.5, the slurry temperature is adjusted from about 35° C. to about 70° C., from about 45° C. to about 65° C., or from about 50° C. to about 60° C. and the slurry solids content is preferably adjusted to about 10 wt. %, about 15 wt. %, about 20 wt. %, about 25 wt. % or about 30 wt. % total solids (“TS”), and ranges thereof, such as from about 15% to about 25% TS or from about 18% to about 22% TS, with one or more of process water, or an aqueous recycle stream. Cellulase loading in the slurry may suitably vary with the cellulose content, but typical loading may be expressed as from about 5 mg to about 50 mg, from about 10 mg to about 50 mg, from about 20 mg to about 50 mg, from about 10 mg to about 50 mg, from about 10 mg to about 40 mg, from about 10 mg to about 30 mg, from about 20 mg to about 50 mg or from about 20 mg to about 40 mg cellulase per gram of cellulose. Alternatively expressed, cellulase loading is from about 10 to about 40 mg enzyme protein per gram of cellulose in treated cellulosic biomass.

Cellulase may be combined with the treated biomass slurry by any means known in the art to achieve a substantially homogeneous admixture, including agitated mixing tanks, in line mixers, pug mill mixers, paddle mixers, ribbon mixers, or in liquefaction reactors such as reactors having at least one mixing section and at least one plug flow section. The enzymatic hydrolysis reactor is typically an agitated vessel designed to hold the treated biomass slurry-cellulase mixture at a temperature suitable for cellulose hydrolysis by cellulase, wherein the volume is sufficient to provide a hold time required for a significant yield of cellulose-derived hexose monosaccharide (“C6”) sugars, e.g., glucose. In some aspects of the present disclosure, the enzymatic hydrolysis vessel may be insulated and/or heated with a heating jacket to maintain hydrolysis temperature. Total enzymatic hydrolysis cycle times of 48 hours, 54 hours, 60 hours, 66 hours, 72 hours, 78 hours, 96 hours and 144 hours, and ranges thereof, are within the scope of the present disclosure. Glucose yields, based on total cellulose content of the biomass slurry is typically from about 30% to about 90%, from about 40% to about 80% from about 30% to about 70% or from about 60% to about 75% of the theoretical value.

For highly viscous treated biomass slurries, such as having a viscosity in excess of about 20,000 cP, about 30,000 cP, about 50,000 cP, about 60,000 cP, about 100,000 cP or about 400,000 cP, mixing with enzymes can be done in two stages. In a first stage, cellulase can be admixed with the biomass in a mixer particularly suited for the processing of highly viscous materials, for instance, a pug mill mixer, a paddle mixer (single or double shaft), or a ribbon mixer (single or double shaft). High viscosity mixers are particularly suited to the method of the present disclosure because thorough mixing of cellulase with the viscous treated biomass slurry enables a rapid viscosity reduction in the subsequent liquefaction step where the viscosity is preferably reduced to less than about 20,000 cP, less than about 15,000 cP, less than about 10,000 cP or even less than about 5,000 cP. The high viscosity mixer may optionally have a jacket to receive cooling or heating medium in order to maintain the temperature of the treated biomass during cellulase addition. Optionally, cooling and heating medium may be incorporated into the internal mixer components (such as rotating shafts, paddles) to further enhance heat exchange. In some aspects, cellulase addition can be done through one or more addition points, for example, multiple spray nozzles, position near the treated biomass inlet. In a second stage, the treated biomass-cellulase admixture may be processed in a mix tank or fiber liquefaction bioreactor. In some aspects, the treated biomass-cellulase admixture may be processed in a fiber liquefaction bioreactor to further reduce the viscosity prior to transfer to a cellulose hydrolysis reactor. The fiber liquefaction bioreactor may be of either a continuous mixing design or a design having at least one continuous mixing section and at least one plug flow section. Optionally, two or more fiber liquefaction bioreactors may be operated in series. In some particular aspects, the fiber liquefaction bioreactor comprises alternating mixing zones and near plug flow zones and the treated biomass-cellulase admixture either flows downward through the tower by gravity or is moved upward by pumping. The treated biomass-cellulase admixture is typically processed in a fiber liquefaction bioreactor until the admixture viscosity is less than about 10,000 cP, less than about 9,000 cP, less than about 8,000 cP, less than about 7,000 cP or less than about 5,000 cP where after it is transferred to a cellulose hydrolysis reactor.

Optionally, additional enzymes such as a hemicellulase (e.g., a xylanase to further hydrolyze the various types of hemicelluloses to xylose), an α-amylase (to liquefy free starch that was formerly entrapped within the cellulose, hemicellulose and/or lignocellulosic matrices), a β-amylase, a glucoamylase (to convert liquefied starch to C6 sugars), an arabinoxylanase, a pullulanase, and/or a protease (to hydrolyze peptide bonds and release starch granules encased in the protein matrix) can be added to the treated cellulosic biomass to generate additional C6 sugars and/or pentose (“C5”) sugars. Non-limiting examples of C6 sugars include glucose, galactose, mannose, and fructose and non-limiting examples of C5 sugars include xylose, arabinose and ribose. The optional enzymes may be admixed with the treated cellulosic biomass at any point of hydrolysis including with the cellulase during high viscosity admixing, at one or more locations in the fiber liquefaction bioreactor and/or in the cellulose hydrolysis reactor.

A hemicellulase, as used herein, refers to a polypeptide that can catalyze hydrolysis of hemicellulose into small polysaccharides such as oligosaccharides, or monosaccharides including xylose and arabinose. Hemicellulases include, for example, the following: endoxylanases, β-xylosidases, α-L-arabinofuranosidases, α-D-glucuronidases, feruloyl esterases, coumarolyl esterases, α galactosidases, β-galactosidases, β-mannanases, and β-mannosidases. A xylanase may be obtained from any suitable source, including fungal and bacterial organisms, such as Aspergillus, Disporotrichum, Penicillium, Neurospora, Fusarium, Trichoderma, Humicola, Thermomyces, Myceliophtora, Crysosporium, and Bacillus. Commercially available preparations comprising xylanase include SHEARZYME®, BIOFEED WHEAT®, BIO-FEED Plus®L, ULTRAFLO®, VISCOZYME®, PENTOPAN MONO®BG, and PULPZYME®HC (Novozymes A/S), and LAMINEX® and SPEZYME®CP (Genencor Int.) An example of a hemicellulase suitable for use in the present invention includes VISCOZYME® (available from Novozymes A/S, Denmark).

Generally any of the classes of proteases are applicable, e.g., acid, base, or neutral, and proteases are commercially available from, for example, Novozymes, Genencor and Solvay. Examples include, for instance, GC106 (available Genencor International), AFP 2000 (available from Solvay Enzymes, Inc.), FermGen™ (which is an alkaline protease available from Genencor International), and Alcalase® (which is an acid protease available from Novozymes Corporation). A commercially available pullulanase is Promozyme® D2, available from Novozyme Corporation.

Commercially available compositions comprising glucoamylase include: AMG 200L, AMG 300 L, AMG E, SAN® SUPER, SAN® EXTRA L, SPIRIZYME® PLUS, SPIRIZYME® FUEL, SPIRIZYME® FG and SPIRIZYME® E (all available from Novozymes); OPTIDEX® 300 and DISTILLASE® L-400 (available from Genencor Int.); and G-ZYME™ G900, G-ZYME™ 480 Ethanol and G990 ZR (all available from Genencor Int.). Examples of commercial acid α-amylases invention include TERMAMYL® SC, LIQUOZYME® SC DS, LIQUOZYME® SC 4X, and SAN™ SUPER (all available from Novozymes AJS, Denmark); and DEX-LO®, SPEZYME® FRED, SPEZYME® AA, and SPEZYME® DELTAAA (all available from Genencor).

Also useful are multienzyme complexes containing multiple carbohydrases, such as Viscozyme® L, available from Novozyme Corporation, which contains arabanase, cellulase, β-glycanase, hemicellulase, and xylanase.

In some optional aspects of the present disclosure, monosaccharides may be extracted or otherwise separated from the hydrolyzed biomass. In such aspects, hydrolyzed biomass is introduced into a sugar recovery apparatus which comprises suitable solids/liquid separation equipment such as, for instance, a screen, filter, centrifuge, settler, percolator, extraction column, flotation vessel, or combination thereof, to generate a liquid fraction comprising monosaccharide sugars and a solids fraction, wherein the solids fraction may suitably be in the form of a cake or slurry. The solids fraction may be washed one or more times for recovery of additional monosaccharide. In some aspects, monosaccharides may be recovered from the solid fraction by counter-current contact of the solid fraction with a washing liquid in a suitable apparatus to form a wash stream comprising extracted monosaccharides. The liquid fraction is combined with a liquid medium and/or the wash streams to form a monosaccharide fraction. The precise composition of the liquid medium and washing liquid are not narrowly critical. However, in various preferred aspects of the present disclosure, the liquid medium and washing liquid may be process water if a monosaccharide fraction of relatively high purity is desired. Although the precise composition of the monosaccharide fraction varies with the biomass composition, generally the monosaccharide compositions comprises at least about 5 wt. %, at least about 6 wt. %, at least about 7 wt. %, at least about 8 wt. %, at least about 9 wt. %, or at least about 10 wt. % monosaccharide. The residual solids fraction comprises non-hydrolyzed cellulose, non-hydrolyzed hemicellulose, non-hydrolyzed lingo-cellulose, polysaccharides (e.g., starch granules), entrained monosaccharides and lignin. The residual solids fraction may be suitably recycled for the recovery of the sugars and the sugar substrates.

In some optional aspects of the present disclosure, the monosaccharide composition may be concentrated to produce a monosaccharide concentrate or syrup having a monosaccharide content of at least about 10 wt. %, at least about 15 wt. %, at least about 20 wt. %, at least about 25 wt. %, at least about 30 wt. %, at least about 35 wt. % or at least about 40 wt. %. Concentration methods are known in the art and include evaporators, reverse osmosis and combinations thereof.

Any of the various enzyme treated biomass solid streams, slurry stream and aqueous streams may be utilized by suitable microorganisms as a substrate for the production of fermentation products. A wide variety of fermentation microorganisms are known in the art, and others may be discovered, produced through mutation, or engineered through recombinant means. Fermentation microorganisms within the scope of the present disclosure include yeast, bacteria, filamentous fungi, microalgae, and combinations thereof. Examples of fermentation products within the scope of the present disclosure include, for instance, acids, alcohols, alkanes, alkenes, aromatics, aldehydes, ketones, triglycerides, fatty acids, biopolymers, proteins, peptides, amino acids, vitamins, antibiotics, pharmaceuticals, and combinations thereof. Non-limiting examples of alcohols include methanol, ethanol, propanol, isopropanol, butanol, ethylene glycol, propanediol, butanediol, glycerol, erythritol, xylitol, sorbitol, and combinations thereof. Non-limiting examples of acids include acetic acid, lactic acid, propionic acid, 3-hydroxypropionic, butyric acid, gluconic acid, itaconic acid, citric acid, succinic acid, levulinic acid, and combinations thereof. Non-limiting examples of amino acids include glutamic acid, aspartic acid, methionine, lysine, glycine, arginine, threonine, phenylalanine, tyrosine, and combinations thereof. Other examples of fermentation products include methane, ethylene, acetone and industrial enzymes.

Fermentation organisms may be wild type microorganisms or recombinant microorganisms, and include Escherichia, Zymomonas, Saccharomyces, Candida, Pichia, Streptomyces, Bacillus, Lactobacillus, and Clostridium. In some aspects of the present disclosure, the fermentation organism is recombinant Escherichia coli, Zymomonas mobilis, Bacillus stearothermophilus, Saccharomyces cerevisiae, Clostridia thermocellum, Thermoanaerobacterium saccharolyticum, or Pichia stipites. In some other aspects of the present disclosure, the microorganism is a microalgae, defined as a eukaryotic microbial organism that contains a chloroplast or plastid, and optionally that is capable of performing photosynthesis, or a prokaryotic microbial organism capable of performing photosynthesis. Microalgae include obligate photoautotrophs, which cannot metabolize a fixed carbon source as energy, as well as heterotrophs, which can live solely off of a fixed carbon source. Microalgae include unicellular organisms that separate from sister cells shortly after cell division, such as Chlamydomonas, as well as microbes such as, for example, Volvox, which is a simple multicellular photosynthetic microbe of two distinct cell types. Microalgae include cells such as Chlorella, Dunaliella, and Prototheca. Microalgae also include other microbial photosynthetic organisms that exhibit cell-cell adhesion, such as Agmenellum, Anabaena, and Pyrobotrys. Microalgae also include obligate heterotrophic microorganisms that have lost the ability to perform photosynthesis, such as certain dinoflagellate algae species and species of the genus Prototheca.

Non-limiting examples of fermentation organisms and associated product include the following. Fermentation of carbohydrates to acetone, butanol and ethanol by: (i) solventogenic Clostridia as described by Jones and Woods (1986) Microbiol. Rev. 50:484-524; (ii) a mutant strain of Clostridium acetobutylicum as described in U.S. Pat. No. 5,192,673; and (iii) a mutant strain of Clostridium beijerinckii as described in U.S. Pat. No. 6,358,717 is known. Fermentation of carbohydrates to ethanol by modified strains of E. coli has been described by Underwood et al., (2002) Appl. Environ. Microbio1.68:6263-6272 and by a genetically modified strain of Zymomonas mobilis is described in US 2003/0162271 A1. Preparation of lactic acid by recombinant strains of E. coli (Zhou et al., (2003) Appl. Environ. Microbiol. 69:399-407), natural strains of Bacillus (US20050250192), and Rhizopus oryzae (Tay and Yang (2002) Biotechnol. Bioeng. 80:1-12) is known. Recombinant strains of E. coli have been used as biocatalysts in fermentation to produce 1,3 propanediol (U.S. Pat. Nos. 6,013,494 and 6,514,733) and adipic acid (Niu et al., (2002) Biotechnol. Prog. 18:201-211). Acetic acid has been produced using recombinant Clostridia (Cheryan et al., (1997) Adv. Appl. Microbiol. 43:1-33) and newly identified yeast strains (Freer (2002) World J. Microbiol. Biotechnol. 18:271-275). Production of succinic acid by recombinant E. coli and other bacteria is disclosed in U.S. Pat. No. 6,159,738 and by mutant recombinant E. coli in Lin et al., (2005) Metab. Eng. 7:116-127). Pyruvic acid has been produced by mutant Torulopsis glabrata yeast (Li et al., (2001) Appl. Microbiol. Technol. 55:680-685) and by mutant E. coli (Yokota et al., (1994) Biosci. Biotech. Biochem. 58:2164-2167). Recombinant strains of E. coli have been used for production of para-hydroxycinnamic acid (US20030170834) and quinic acid (US20060003429).

Production of amino acids by fermentation has been accomplished using auxotrophic strains and amino acid analog-resistant strains of Corynebacterium, Brevibacterium, and Serratia. For example, production of histidine using a strain resistant to a histidine analog is described in Japanese Patent Publication No. 8596/81 and using a recombinant strain is described in EP 136359. Production of tryptophan using a strain resistant to a tryptophan analog is described in Japanese Patent Publication Nos. 4505/72 and 1937/76. Production of isoleucine using a strain resistant to an isoleucine analog is described in Japanese Patent Publication Nos. 38995/72, 6237/76, 32070/79. Production of phenylalanine using a strain resistant to a phenylalanine analog is described in Japanese Patent Publication No. 10035/81. Production of tyrosine using a strain requiring phenylalanine for growth, resistant to tyrosine (Agr. Chem. Soc. Japan 50 (1) R79-R87 (1976), or a recombinant strain (EP263515, EP332234), and production of arginine using a strain resistant to an L-arginine analog (Agr. Biol. Chem. (1972) 36:1675-1684, Japanese Patent Publication Nos. 37235/79 and 150381/82) have been described. Phenylalanine has also been produced by Eschericia coli strains ATCC 31882, 31883, and 31884. Production of glutamic acid in a recombinant Coryneform bacterium is described in U.S. Pat. No. 6,962,805. Production of threonine by a mutant strain of E. coli is described in Okamoto and Ikeda (2000) J. Biosci Bioeng. 89:87-79. Methionine was produced by a mutant strain of Corynebacterium lilium (Kumar et al, (2005) Bioresour. Technol. 96: 287-294). Production of peptides, enzymes, and other proteins by microorganisms is also known as disclosed in U.S. Pat. Nos. 6,861,237, 6,777,207 and 6,228,630. Production of triglycerides, fatty acids and fatty acid esters (e.g., biodiesel) by microalgae is also known as disclosed in U.S. Pat. Nos. 7,883,882, 8,187,860, 8,278,090 and 8,222,010, and published U.S. App. Nos. 20100303957, 20110047863 and 20110250658.

Selection of suitable fermentation conditions may suitably be done by those skilled in the art based on (i) the identity of the microorganism or combination of microorganisms, (ii) the characteristics of the fermentation substrate medium and (iii) the associated fermentation product. Fermentation may be aerobic or anaerobic. Single and multi-step fermentations are within the scope of the present disclosure. The fermentation substrate medium may be supplemented with additional nutrients required for microbial growth. Supplements may include, for example, yeast extract, vitamins, growth promoters, specific amino acids, phosphate sources, nitrogen sources, chelating agents, salts, and trace elements. Components required for production of a specific product made by a specific microorganism may also be included, such as an antibiotic to maintain a plasmid or a cofactor required in an enzyme catalyzed reaction. Also additional sugars may be included to increase the total sugar concentration. Suitable fermentation conditions are achieved by adjusting these types of factors for the growth and target fermentation product production by a microorganism. The fermentation temperature can be any temperature suitable for growth and production of the nutrients of the present disclosure, such as from about 20° C. to about 45° C., from about 25° C. to about 40° C., or from about 28° C. to about 32° C. The fermentation pH can be adjusted or controlled by the addition of acid or base to the fermentation mixture. In such cases when ammonia is used to control pH, it also conveniently serves as a nitrogen source. The pH is maintained from about 3.0 to about 8.0, from about 3.5 to about 7.0 or from about 4.0 to about 6.5. The fermentation mixture can optionally be maintained to have a dissolved oxygen content during the course of fermentation to maintain cell growth and to maintain cell metabolism for production of the nutrients. The oxygen concentration of the fermentation medium can be monitored using known methods, such as through the use of an oxygen electrode. Oxygen can be added to the fermentation medium using methods known in the art such as through agitation and aeration of the medium by stirring, shaking or sparging. Fermentation may occur subsequent to enzymatic hydrolysis, or may occur concurrently with enzymatic hydrolysis by SSF. In some aspects of the present disclosure, SSF can keep the sugar levels produced by hydrolysis low thereby reducing potential product inhibition of the hydrolysis enzymes, reducing sugar availability for contaminating microorganisms, and improving the conversion of treated biomass to monosaccharides and/or oligosaccharides.

Hexose sugar fermenting organisms include yeasts. Any of a variety of yeasts can be employed as the yeast in the present method. Typical yeasts include any of a variety of commercially available yeasts, such as commercial strains of Saccharomyces cerevisiae. Suitable commercially available strains include ETHANOL RED (available from Red Star/Lesaffre, USA); BioFenn HP and XR (available from North American Bioproducts); FALI (available from Fleischmann's Yeast); SUPERSTART (available from Lallemand); GERT STRAND (available from Gert StrandAB, Sweden); FERMIOL (available from DSM Specialties); and Thennosac (available from Alltech). In some aspects, the hexose fermenting organism is a recombinant yeast having at least one transgene expressing an enzyme useful for converting mono- and/or oligo-saccharides to ethanol.

In aspects of the present disclosure directed to the generation of ethanol by yeast, the fermentation medium has a pH of from about 3.5 to about 6, from about 3.5 to about 5 or from about 4 to about 4.5. If pH adjustment is required, mineral acids such as sulfuric acid, hydrochloric acid or nitric acid may be used, or bases such as ammonia (ammonium hydroxide) or sodium hydroxide may be used. To enhance the efficacy of ethanol fermentation and increase the ethanol yield, additional nutrients may be added to enhance yeast proliferation. Such nutrient includes, without limitation, free-amino-nitrogen (FAN), oxygen, phosphate, sulfate, magnesium, zinc, calcium, and vitamins such as inositol, pantothenic acid, and biotin. Typical sources of FAN include urea, ammonium sulfate, ammonia, amino acids, and α-amino nitrogen groups of peptides and proteins. Added FAN content is preferably from about 1.2 to about 6 mg N/g starch, for example 1.2, 2.4, 3.6, 4.8 or 6mg N/g starch. In the case of urea, it is preferred to add from about 2.4 to about 12 mg urea per gram of starch, for example, 2.4, 4.8, 7.2, 9.6 or 12 mg urea per gram of starch. Yeast foods that supply, for example, vitamins (such a B vitamins and biotin), minerals (such as from salts of magnesium and zinc) and micronutrients and nutrients can be added to the fermentation medium. Yeast foods can include autolyzed yeast and plant extracts and are typically added to a concentration of from about 0.01 to about 1 g/L, for example from about 0.05 to about 0.5 g/L. Bactericides can also optionally be added to the fermentation medium. Examples of typical bactericides include virginiamycin, nisin, erythromycin, oleandomycin, fiavomycin, and penicillin G. In the case of virginiamycin, a concentration of from about 1 ppm to about 10 ppm is preferred.

Suitable pentose sugar (e.g., xylose) fermenting organisms include yeasts. Such yeasts include Pachysolen tannophilus, Pichia stipites, Candida diddensii, Candida utilis, Candida tropicalis, Candida subtropicalis, Saccharomyces diastaticus, Saccharomycopsis fibuligera and Torula candida. In some aspects, the pentose fermenting organism is a recombinant yeast having at least one transgene expressing an enzyme useful for converting mono- and/or oligo-saccharides to ethanol. For instance, the genome of P. stipites may be incorporated into S. cerevisiae by a gene shuffling method to produce a hybrid yeast capable of producing bioethanol from xylose while retaining the ability to survive in high concentrations of ethanol.

In some aspects of the present disclosure, organisms capable of fermenting both hexose and pentose sugars are utilized to convert monosaccharides to ethanol. Typically, such organisms are strains of S. cerevisiae having transgenes encoding for one or more enzymes capable of converting pentose sugars to ethanol.

In aspects of the present disclosure wherein the fermentation medium comprises enzyme treated cellulosic biomass comprising non-hydrolyzed cellulosic material such as cellulose, hemicellulose, lingo-cellulose, and fragments thereof, the fermentation organism source may optionally comprise at least one species of cellulolytic organism capable of breaking down and metabolizing non-hydrolyzed cellulose, hemicellulose and/or lingo-cellulose present in the fermentation medium to ethanol. Such cellulolytic organisms are known in the art and include Escherichia coli, Zymomonas mobilis, Bacillus stearothermophilus, Saccharomyces cerevisiae, Clostridia thermocellum, Thermoanaerobacterium saccharolyticum, Pichia stipites and Pachysolen tannophilus. Also within the scope of the present disclosure are cellulolytic bacteria having one or more transgenes encoding for the ethanol-producing pathway. In some other aspects of the present disclosure the fermentation organism source further comprises at least one species of cellulolytic organism capable of breaking down non-hydrolyzed hemicellulose present in the adjusted combined liquefaction admixture and synthesizing ethanol.

Fermentation products may be recovered using any of various methods known in the art. For instance, fermentation products may be separated from other fermentation components by distillation (e.g., azeotropic distillation), liquid-liquid extraction, solid-liquid extraction, adsorption, gas stripping, membrane evaporation, pervaporation, centrifugation, crystallization, filtration, microfiltration, nanofiltration, ion exchange, or electrodialysis. As a specific example, methanol, ethanol, or other fermentation products having sufficient volatility, may be recovered from a fermentation mixture by distillation. In another example, 1-butanol may be isolated from a fermentation mixture using methods known in the art for acetone-butanol-ethanol (“ABE”) fermentations (see for example, Durre, Appl. Microbiol. Biotechnol. 49:639-648 (1998), Groot et al., Method. Biochem. 27:61-75 (1992), and references therein), for instance by solids removal followed by isolation by distillation, liquid-liquid extraction, adsorption, gas stripping, membrane evaporation, or pervaporation. In yet another example, 1,3-propanediol may be isolated from a fermentation mixture by extraction with an organic solvent, distillation, and column chromatography (see U.S. Pat. No. 5,356,812). In yet another example, amino acids may be collected from fermentation mixture by methods such as ion-exchange resin adsorption and/or crystallization. Selection of a suitable separation method for any particular fermentation product may be done by those skilled in the art.

In accordance with the present disclosure, any of the various organic rich fractions such as cleaned biowaste, isolated insoluble biomass, RDF and/or SRF, may be converted to secondary products by gasification methods or syngas fermentation methods known in the art. In gasification methods, the organic rich fraction is heated to high temperature in an oxygen-lean atmosphere or in the essential absence of oxygen to produce syngas (primarily hydrogen and carbon monoxide) that is subsequently reacted to form a gas stream comprising one or more carbon compounds. For instance, in a Fischer-Tropsch (“FT”) synthesis step, H₂ and CO in syngas are reacted over a catalyst (e.g., iron or cobalt) to form a wide range of hydrocarbon chains of various lengths. The FT reaction is typically performed at a pressure of from about 20 bar to about 40 bar within a temperature range of either from about 200° C. to about 250° C. or from about 300° C. to about 350° C. Iron catalysts are generally used at the higher temperature range to produce olefins for a lighter gasoline product and cobalt catalysts are used at the lower temperature range to produce longer-chained products that can be cracked to diesel. Methanol production from syngas typically involves reacting CO, H₂ and a small amount of CO₂ over a copper-zinc oxide catalyst wherein the reaction proceeds via a water gas shift reaction, followed by hydrogenation of CO₂. The process is typically performed at a pressure of from about 50 to about 100 bar and within a temperature range of from about 220° C. to about 300° C. Mixed alcohol synthesis from syngas, is similar to both FT and methanol synthesis using catalysts modified from those methods with added alkali metals to promote the mixed alcohol reaction, wherein the mole ratio of H₂ to CO is from bout 1:1 to about 1.2:1.

In syngas fermentation methods, a variety of microorganisms can use syngas as an energy and carbon source to produce fermentation products such as ethanol, butanol, acetate, formate and butyrate. Such organisms include Acetobacterium woodii, Butyribacterium methylotrophicum, Clostridium carboxidivorans P7, Eubacterium limosu, Moorella and Peptostreptococcus productus. For instance, certain anaerobic microorganisms can produce ethanol and other useful products from CO by fermentation. For example: U.S. Pat. No. 5,173,429 describes Clostridium ljungdahlii ATCC No. 49587, an anaerobic microorganism that produces ethanol and acetate from syngas; U.S. Pat. No. 5,807,722 describes a method and apparatus for converting syngas into organic acids and alcohols using Clostridium ljungdahlii ATCC No. 55380; U.S. Pat. No. 6,136,577 describes a method and apparatus for converting syngas into ethanol using Clostridium ljungdahlii ATCC No. 55988 and 55989; U.S. Publication No. 20070275447 discloses a clostridium bacterial species (Clostridium carboxidivorans, ATCC BAA-624, “P7”) that is capable of synthesizing biofuels from syngas; and U.S. Pat. No. 7,704,723 discloses a clostridium bacterial species (Clostridium ragsdalei, ATCC BAA-622, “P11”) that is capable of synthesizing biofuels from waste gases. US Publication No. 20140120591 discloses an acidigenic Clostridium tyrobutyricum species (ITRI04001) that is capable of synthesizing volatile fatty acids (e.g., formic acid, acetic acid, lactic acid, propanoic acid, butyric acid, and mixtures thereof) from syngas. Fermentation conditions are typically at atmospheric pressure to 2 bar, and a temperature range of from aboutl5° C. to about 55° C., with the selection of specific fermentor conditions and pH depending on the fermentive microorganism.

When introducing elements of the present disclosure or the aspects(s) or embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have elements that do not differ from the literal language of the claims, or if they include equivalent elements with insubstantial differences from the literal languages of the claims.

1. A method for preparing a cleaned biowaste stream from mixed solid waste, wherein the mixed solid waste comprises biowaste, inorganic compounds, mixed plastics, rolling stock, flat stock, bagged waste, and ferrous metals, the method comprising:
(a) classifying mixed solid waste in a first classifying step to form a first undersize stream and a first oversize stream wherein (1) the first undersize stream has an average particle size of less than from about 60 mm to about 100 mm and is enriched in biowaste as compared to the first oversize stream and (2) the first oversize stream is enriched in rolling stock and flat stock as compared to the first undersize stream;
(b) classifying the first oversize stream in a second classifying step to form a second undersize stream and a second oversize stream wherein (1) the second undersize stream has an average particle size of less than from about 170 mm to about 230 mm and is enriched in rolling stock as compared to the first oversize stream and (2) the second oversize stream is enriched in flat stock as compared to the second undersize stream;
(c) classifying the second oversize stream in a third classifying step to form a third undersize stream and a third oversize stream wherein (1) the third undersize stream has an average particle size of less than from about 320 mm to about 380 mm and is enriched in bagged waste as compared to the third oversize stream and (2) the third oversize stream is enriched in flat stock as compared to the second oversize stream;
(d) classifying the second and third undersize streams in a fourth classifying step to form a fines stream, a rolling stock stream and a flat stock stream wherein (1) the fines stream is enriched in biowaste as compared to the rolling stock stream and the flat stock stream, (2) the rolling stock stream in enriched in plastic as compared to the fines stream and flat stock stream, and (3) the flat stock stream is enriched in paper and cardboard as compared to the fines stream and the rolling stock stream;
(e) combining the first undersize stream and the fourth classifying step fines stream to form a combined biowaste stream and classifying the combined biowaste stream in a fifth classifying step to form a first reject stream and an oversize crude biowaste stream wherein (1) the first reject stream has an average particle size of less than from about 5 mm to about 15 mm and is enriched in inorganic compounds as compared to the crude biowaste stream and (2) the oversize crude biowaste stream is enriched in cellulose as compared to the first reject stream;
(f) classifying the oversize crude biowaste stream in a sixth classifying step to form a second reject stream and an intermediate biowaste stream wherein the second reject stream has a greater density in grams per cm³ as compared to the intermediate biowaste stream and the second reject stream is enriched in inorganic compounds as compared to the intermediate biowaste stream;
(g) classifying the intermediate biowaste stream in a seventh classifying step to form a cleaned biowaste undersize stream and a fourth oversize stream wherein (1) the cleaned biowaste stream has an average particle size of less than from about 20 mm to about 30 mm and is enriched in biowaste as compared to the fourth oversize stream and (2) the fourth oversize stream is enriched in paper and plastic as compared to the cleaned biowaste stream; and
(h) classifying the fourth classifying step rolling stock stream in an eighth classifying step to form rolling stock recovered plastics stream comprising an HDPE plastic stream, a PET plastic stream, and mixed plastic stream.

2. The method of claim 1 wherein the first classifying step is a screening fractionation step using a first screen having 60 mm to 100 mm openings, the second classifying step is a screening fractionation step using a second screen having 170 mm to 230 mm openings, the third classifying step is a screening fractionation using a third screen having 320 mm to 380 mm openings, the fourth classifying step is a ballistic separation step, the fifth classifying step is a screening fractionation step using a fourth screen having 5 mm to 15 mm openings, the sixth classifying step is density separation step, the seventh fractionation step is a screening fractionation step using a fifth screen having 20 mm to 30 mm openings, and the eighth fractionation step is an optical sorting step.

3. (canceled)

4. The method of claim 2 wherein the first screen is integral to a first rotating trommel, the second screen and third screen are integral to a two-stage second rotating trommel, the fourth screen is integral to a third rotating trommel and the fifth screen is integral to a fourth rotating trommel.

5. The method of claim 2 wherein the first screen, second screen and third screen are integral to a first rotating trommel, the fourth screen is integral to a second rotating trommel and the fifth screen is integral to a third rotating trommel.

6-7. (canceled)

8. The method of claim 2 wherein the density separator is an air classifier or a windshifter.

9. The method of claim 2 further comprising (a) classifying the fourth oversize stream with an optical sorter to form a recovered stream enriched in biowaste as compared to the fourth oversize stream and a recovered plastics stream enriched in plastic compounds as compared to the recovered stream, (b) milling the recovered stream enriched in biowaste to achieve an average particle size of from about 15 mm to about 30 mm and combining the milled recovered stream enriched in biomass with the cleaned biowaste stream, and (c) combining the recovered plastics stream with the ballistic separation rolling stock stream.

10-13. (canceled)

14. The method of claim 1 wherein the cleaned biowaste stream comprises at least one of cellulose, hemicellulose, lignocellulose and starch, the method further comprising (a) contacting the cleaned biowaste stream with a mineral acid to form acid impregnated cleaned biowaste having an acid concentration of from about 0.01 to about 0.05 kg acid per kg cleaned biowaste on a solids basis and a water content of from about 10 percent by weight to about 60 percent by weight, and (b) processing the acid impregnated cleaned biowaste by steam explosion, enzymatic hydrolysis, or a combination thereof, to form a hydrolyzed biowaste stream comprising glucose.

15-20. (canceled)

21. A method for preparing a cleaned biowaste stream from mixed solid waste, wherein the mixed solid waste comprises biowaste, inorganic compounds, mixed plastics, rolling stock, flat stock and ferrous metals, the method comprising:
(a) classifying mixed solid waste in a first classifying step to form a first undersize stream and a first oversize stream wherein (1) the first undersize stream has an average particle size of less than from 60 mm to 100 mm and enriched in biowaste as compared to the first oversize stream and (2) the first oversize stream is enriched in rolling stock and flat stock as compared to the first undersize stream;
(b) classifying the first oversize stream in a second classifying step to form a second undersize stream and a second oversize stream wherein (1) the second undersize stream has an average particle size of less than 170 mm to 380 mm and is enriched in rolling stock as compared to the first oversize stream and (2) the second oversize stream is enriched in flat stock as compared to the second undersize stream;
(c) classifying the second undersize stream in a third classifying step to form a fines stream, a rolling stock stream and a flat stock stream wherein (1) the fines stream is enriched in biowaste as compared to the rolling stock stream, (2) the rolling stock stream in enriched in plastic as compared to the fines stream and flat stock stream, and (3) the flat stock stream is enriched in paper and cardboard as compared to the fines stream and the rolling stock stream;
(d) classifying the rolling stock stream in a fourth classifying step to form a rolling stock recovered plastics streams comprising an HDPE plastic stream, a PET plastic stream, and mixed plastic stream; and
(e) combining the first undersize stream and the third classifying step fines stream to form a combined biowaste stream and classifying the combined biowaste stream in a fifth classifying step to form a first reject stream and a purified stream comprising cleaned biowaste wherein (1) the first reject stream has an average particle size of less than 5 mm to 15 mm and is enriched in inorganic compounds as compared to the purified oversize stream and (2) the purified stream is enriched in cellulose as compared to the first reject stream.

22. The method of claim 21 wherein the first classifying step is a screening fractionation step using a first screen having openings of from 60 mm to 100 mm, the second classifying step is a screening fractionation step using a second screen having openings of from 170 mm to 380 mm, the third classifying step is a ballistic separation step, the fourth classifying step is an optical sorting step, and the fifth fractionation step is a screening step using a third screen having openings of from 5 mm to 15 mm.

23-32. (canceled)

33. The method of claim 21 further comprising classifying the purified stream comprising cleaned biowaste by density separation to form a second reject stream and an intermediate biowaste stream wherein the second reject stream has a greater density in grams per cm³ as compared to the intermediate biowaste stream and the second reject stream is enriched in inorganic compounds as compared to the intermediate biowaste stream.

34. The method of claim 33 further comprising classifying the intermediate biowaste stream by screening with a screen having a mesh size of about 20 mm to about 30 mm to form a cleaned biowaste undersize stream and a cleaned biowaste oversize stream wherein (a) the cleaned biowaste stream is enriched in biowaste as compared to the cleaned biowaste oversize stream and (b) the cleaned biowaste oversize stream is enriched in paper and plastic as compared to the cleaned biowaste stream.

35-43. (canceled)

44. The method of claim 21 further comprising;
(a) contacting the purified stream comprising cleaned biowaste with a mineral acid to form acid impregnated cleaned biowaste having an acid concentration of from about 0.01 to about 0.05 kg acid per kg cleaned biowaste on a solids basis;

(b) contacting the acid impregnated cleaned biowaste with steam (1) at a temperature of from about 150° C. to about 250° C. and (2) a pressure of from about 400 kPa gauge to about 1750 kPa for (3) from about 1 minute to about 60 minutes; and

(c) (1) reducing the pressure to less than 35 kPa in a single step or (2) reducing the pressure to from about 345 kPa to about 1380 kPa in a first pressure reduction step and holding for a period of time from about 0.5 minutes to about 30 minutes to form aqueous stream comprising glucose.

45-71. (canceled)

72. An apparatus for classifying mixed solid waste comprising biowaste, inorganic compounds, mixed plastics, rolling stock, flat stock, bagged waste, ferrous metals, and residual derived fuel, the apparatus comprising:
(a) a first classifying screen having a mesh size of from about 60 mm to about 100 mm for receiving and classifying mixed solid waste to form a first undersize stream and a first oversize stream wherein (1) the first undersize stream is enriched in biowaste as compared to the first oversize stream and (2) the first oversize stream is enriched in rolling stock and flat stock as compared to the first undersize stream;
(b) a second classifying screen having a mesh size of from about 170 mm to about 380 mm for receiving and classifying the first oversize stream to form a second undersize stream and a second oversize stream wherein (1) the second undersize stream is enriched in rolling stock as compared to the first oversize stream and (2) the second oversize stream is enriched in flat stock as compared to the second undersize stream;
(c) a ballistic separator for receiving and classifying the second undersize stream to form a fines stream, a rolling stock stream and a flat stock stream wherein (1) the fines stream is enriched in biowaste as compared to the rolling stock stream, (2) the rolling stock stream in enriched in plastic as compared to the fines stream and flat stock stream, and (3) the flat stock stream is enriched in paper and cardboard as compared to the fines stream and the rolling stock stream;
(d) an optical sorter for receiving and classifying the ballistic separator rolling stock stream to form ballistic separation rolling stock recovered plastics streams comprising an HDPE plastic stream, a PET plastic stream, and mixed plastic stream; and
(e) a purification classifying screen having a mesh size of from about 5 mm to about 15 mm for receiving and classifying the first undersize stream and the ballistic separation fines stream to form a first reject undersize stream and a purification oversize stream comprising cleaned biowaste wherein (1) the first reject undersize stream is enriched in inorganic compounds as compared to the purification oversize stream and (2) the purification oversize stream is enriched in cellulose as compared to the first reject undersize stream.

73. The apparatus of claim 72 further comprising a third classification screen wherein the second classification screen has a mesh size of from about 170 mm to about 230 mm and the third classification screen has a mesh size of from about 320 mm to about 380 mm, wherein the third classification screen receives and classifies the second oversize stream to form a third undersize stream and a third oversize stream wherein (a) the third undersize stream is enriched in bagged waste as compared to the second undersize stream and (b) the third oversize stream is enriched in flat stock as compared to the second oversize stream, the apparatus further comprising a bag opener for receiving and processing the third undersize stream through a bag opener and combining the resulting third undersize stream with the second undersize stream, wherein the ballistic separator receives and classifies the second undersize stream and the third undersize stream after processing by the bag opener.

74. (canceled)

75. The apparatus of claim 72 further comprising a first X-ray separation apparatus, a second X-ray separation apparatus, a third X-ray separation apparatus and two sequentially arranged classifying screens for receiving and classifying the first undersize stream and the ballistic separation fines stream prior to the purification screen, the first screen having openings of from about 20 mm to about 30 mm and the second screen having openings of form about 40 mm to about 60 mm wherein the sequentially arranged screens form a first primary undersize stream, a second primary undersize stream and a primary oversize stream wherein:
(a) the first primary undersize stream is classified in the purification classifying screen and the purification oversize stream is classified in the first X-ray separation apparatus to form (i) a first cleaned biowaste stream having an average particle of less than 25 mm and (ii) a waste stream enriched in organic material as compared to the first primary undersize stream;
(b) the second primary undersize stream is classified in a second X-ray separation apparatus to form (i) a second cleaned biowaste stream having an average particle of from about 25 mm to about 50 mm and (ii) a waste stream enriched in organic material as compared to the second primary undersize stream;
(c) the primary oversize stream is classified in a third X-ray separation apparatus to form (i) a third cleaned biowaste stream having an average particle of from about 50 mm to about 80 mm and (ii) a waste stream enriched in organic material as compared to the second primary undersize stream; and
(d) the second and third cleaned biowaste streams are comminuted to produce a combined comminuted cleaned biowaste stream having an average particle size of less than 25 mm and the combined comminuted cleaned biowaste stream is combined with the first cleaned biowaste stream.

76-78. (canceled)

79. The apparatus of claim 72 further comprising a density separator for receiving and classifying the purification oversize stream to form a second reject stream and an intermediate biowaste stream wherein the second reject stream has a greater density in grams per cm³ as compared to the intermediate biowaste stream and the second reject stream is enriched in inorganic compounds as compared to the intermediate biowaste stream.

80. The apparatus of claim 79 further comprising a classification screen having openings of from about 20 mm to about 30 mm for receiving and classifying the intermediate biowaste stream to form a cleaned biowaste undersize stream and a cleaned biowaste oversize stream wherein (a) the cleaned biowaste undersize stream is enriched in biowaste as compared to the cleaned biowaste oversize stream and (b) the cleaned biowaste oversize stream is enriched in paper and plastic as compared to the cleaned biowaste undersize stream.

81. The apparatus of claim 80 further comprising:
(a) an optical sorter for receiving and classifying the cleaned biowaste oversize stream to form a recovered stream enriched in biowaste as compared to the cleaned biowaste oversize stream and a recovered plastics stream enriched in plastic compounds as compared to the recovered stream enriched in biowaste; and
(b) a mill for receiving and milling the recovered stream enriched in biowaste to achieve an average particle size of from about 15 mm to about 30 mm.

82-87. (canceled)

88. The apparatus of claim 72 further comprising:
(a) an impregnator comprising a cleaned biowaste input, an input for an aqueous stream, a dilute acid stream or a dilute base stream, a mixing means, and a moisture impregnated biowaste output, the impregnator configured to provide moisture impregnated biowaste having a water content of from about 10 percent by weight to about 60 percent by weight; and
(b) a steam explosion device comprising an input for receiving the moisture impregnated biowaste, a steam input and a steam exploded biomass outlet, said steam explosion device configured to achieve a temperature of from about 150° C. to about 250° C. and a pressure of from about 400 kPa gauge to about 1750 kPa gauge, said steam explosion device capable of (1) reducing the pressure to less than 35 kPa in a single step or (2) reducing the pressure to greater than 35 kPa in a first step and to less than 35 kPa in a second step to form hydrolyzed biowaste comprising glucose.

89. The apparatus of claim 88 further comprising an enzymatic hydrolysis system, said enzymatic hydrolysis system comprising (a) a pH adjustment means and a source of an acid and a source of a base, (b) a source of enzyme comprising at least comprising least one of cellulase and/or hemicellulase and (c) a hydrolysis vessel comprising a mixing means, wherein the enzymatic hydrolysis system receives the hydrolyzed biowaste, adjusts the pH thereof to from about 4 to about 6.5, receives and admixes the enzyme therewith to form a enzymatically hydrolyzed biowaste stream comprising glucose.

90-92. (canceled)
